(19) United States
(12) Patent Application Publication
(10) Pub. No.: US 2026/0206053 A1
(43) Pub. Date: Jul. 16, 2026

(54) Triggered Transmission Opportunity (TXOP) Sharing Power Save Mode Operation

(71) Applicant: Ofinno, LLC, Reston, VA (US)

(72) Inventors: Jeongki Kim, Fairfax, VA (US); Leonardo Alisasis Lanante, Reston, VA (US); Esmael Hejazi Dinan, McLean, VA (US); Serhat Erkucuk, Reston, VA (US)

(73) Assignee: Ofinno, LLC, Reston, VA (US)

(21) Appl. No.: 19/560,521

(22) Filed: Mar. 9, 2026

Related U.S. Application Data
(63) Continuation of application No. PCT/US2024/045226, filed on Sep. 5, 2024.
(60) Provisional application No. 63/537,232, filed on Sep. 8, 2023.

(51) Int. Cl. H04W 74/0808

(52) U.S. Cl. CPC H04W 74/0808

(57) ABSTRACT

In an aspect, an access point (AP) receives from a first station (STA) a first frame indicating enabling or disabling of a triggered transmit opportunity (TXOP) sharing (TXS) power save mode at the first STA. The AP transmits a trigger frame sharing a time period of a TXOP with a second STA. The AP refrains from transmission to the first STA during the time period based on the first frame indicating enabling of the TXS power save mode at the first STA. In another aspect the first STA receives from the AP a first frame sharing a time period of a TXOP with the second STA. The first STA transitions a power state of the first STA to a doze state based on a TXS power save mode being enabled at the first STA.

### CROSS-REFERENCE TO RELATED APPLICATIONS

This application is a continuation of International Application No. PCT/US2024/045226, filed Sep. 5, 2024, which claims the benefit of U.S. Provisional Application No. 63/537,232, filed Sep. 8, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of target wake time (TWT) operation.

FIG. 4 illustrates an example of TWT operation in an environment including an AP multi-link device (AP MLD) and a station multi-link device (STA MLD).

FIG. 5 illustrates an example TWT element which may be used to support individual TWT operation.

FIG. 6 illustrates an example TWT element which may be used to support restricted TWT (r-TWT) operation.

FIG. 7 illustrates an example of individual TWT operation.

FIG. 8 illustrates an example of broadcast TWT operation.

FIG. 9 illustrates an example of TWT protection in individual TWT operation.

FIG. 10 illustrates an example MRTT frame which may be used in a TXS procedure.

FIG. 11 illustrates an example of a TXS procedure (Mode=1).

FIG. 12 illustrates an example of a TXS procedure (Mode=2).

FIG. 13 is an example that illustrates an example TXS procedure between multi-link devices (MLDs).

FIG. 14 is an example that illustrates an inefficient STA operation that may occur during a TXS procedure.

FIG. 15 is an example that illustrates a TXS PS (PS) mode.

FIG. 16 is an example that illustrates a STA enabling or disabling the TXS PS mode according to an embodiment.

FIG. 17 is an example that illustrates a STA enabling or disabling the TXS PS mode according to another embodiment.

FIG. 18 is an example that illustrates a STA enabling or disabling the TXS PS mode according to a further embodiment.

FIG. 19 illustrates an example control information subfield which may be used in embodiments.

FIG. 20 illustrates an example action frame which may be used in embodiments.

FIG. 21 illustrates an example process according to an embodiment.

FIG. 22 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

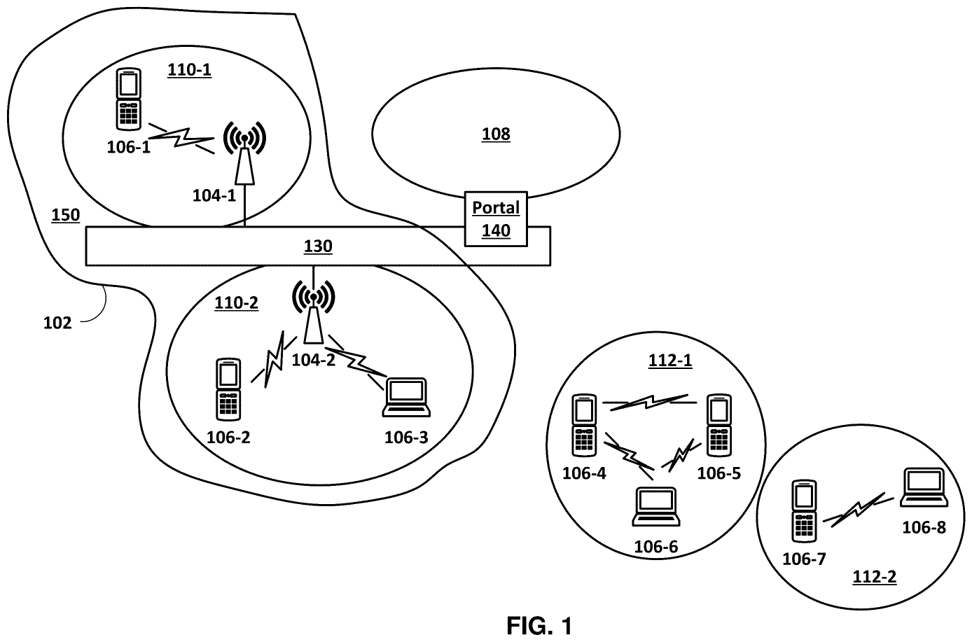

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 320 MHz by bonding together multiple 20 MHz channels.

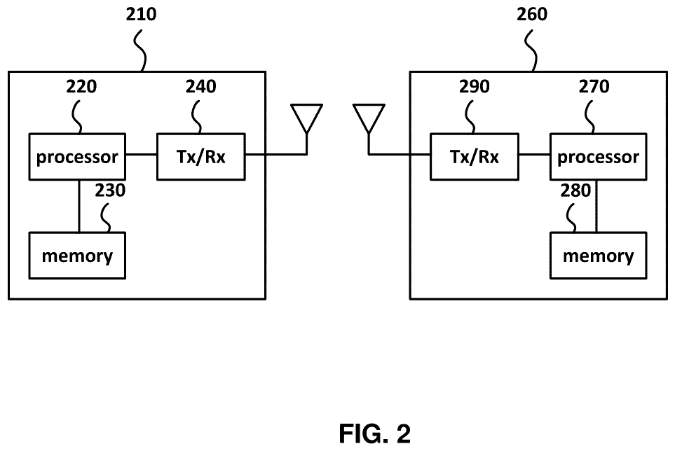

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

Target wake time (TWT), a feature introduced in the IEEE 802.11ah standard, allows STAs to manage activity in the BSS by scheduling STAs to operate at different times to reduce contention. TWTs may allow STAs to reduce the required amount of time that a STA utilizing a power management mode may be awake. TWTs may be individual TWTs or broadcast TWTs. Individual TWTs follow a negotiated TWT agreement between STAs. Broadcast TWTs are based on a schedule set and provided to STAs by an AP.

In an individual TWT, a STA that requests a TWT agreement is called a TWT requesting STA. The TWT requesting STA may be a non-AP STA for example. The STA that responds to the request is called a TWT responding STA. The TWT responding STA may be an AP for example. The TWT requesting STA is assigned specific times to wake up and exchange frames with the TWT responding STA. The TWT requesting STA may communicate wake scheduling information to the TWT responding STA. The TWT responding STA may transmit TWT values to the TWT requesting STA when a TWT agreement is established between them.

When explicit TWT is employed, the TWT requesting STA may wake up and perform a frame exchange. The TWT requesting STA may receive a next TWT information in a response from the TWT responding STA. When implicit TWT is used, the TWT requesting STA may calculate a next TWT by adding a fixed value to the current TWT value.

The TWT values for implicit TWT may be periodic. The TWT requesting STA operating with an implicit TWT agreement may determine a next TWT service period (TWT SP) start time by adding a value of a TWT wake interval associated with the TWT agreement to the value of the start time of the current TWT SP. The TWT responding STA may include the start time for a series of TWT SPs corresponding to a single TWT flow identifier of an implicit TWT agreement in a target wake time field of a TWT element. The TWT element may contain a value of ‘accept TWT’ in a TWT setup command field. The start time of the TWT SP series may indicate the start time of a first TWT SP in the series. Start times of subsequent TWT SPs may be determined by adding the value of the TWT wake interval to the start time of the current TWT SP. In an example, the TWT requesting STA, awake for an implicit TWT SP, may enter a doze state after the TWT SP has elapsed or after receiving an end of service period (EOSP) field equal to 1 from the TWT responding STA, whichever occurs first.

A TWT session may be negotiated between an AP and a STA. The TWT session may configure a TWT SP of DL and UL traffic between the AP and the STA. Expected traffic may be limited within the negotiated SP. The TWT SP may start at a specific time. The TWT SP may run for a SP duration. The TWT SP may repeat every SP interval.

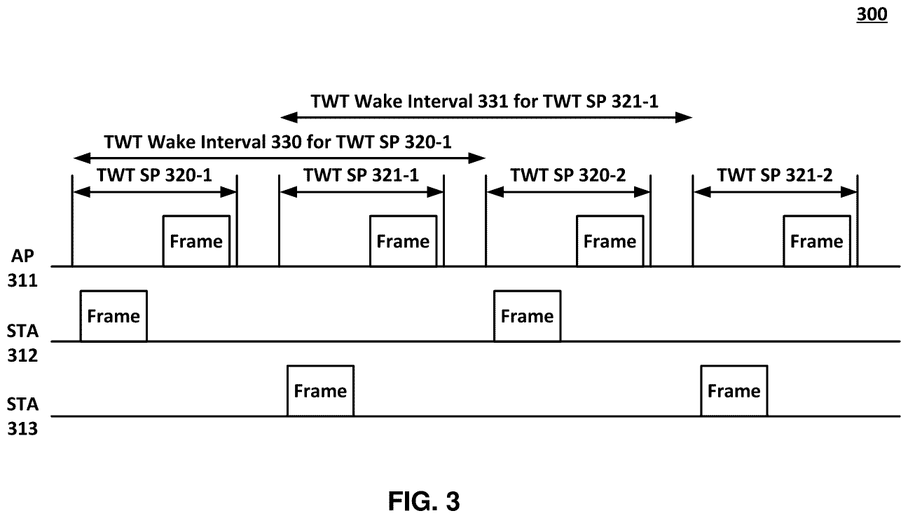

FIG. 3 illustrates an example 300 of TWT operation. As shown in FIG. 3, example 300 includes an AP 311, a STA 312, and a STA 313. AP 311 and STA 312 may establish a TWT SP 320. AP 311 and STA 313 may establish a TWT SP 321. TWT SP 320 and TWT SP 321 may repeat as shown in FIG. 3, such that TWT SP 320 may include a first TWT SP 320-1 and a second TWT SP 320-2, and such that TWT SP 321 may include a first TWT SP 321-1 and a second TWT SP 321-2.

AP 311 and STA 312 may exchange frames during first TWT SP 320-1. STA 312 may enter a doze state at the end of TWT SP 320-1 and may remain in the doze state until the start of second TWT SP 320-2. The start of second TWT SP 320-2 may be indicated by a TWT wake interval 330 associated with TWT SP 320. AP 311 and STA 312 may again exchange frames during second TWT SP 320-2.

Similarly, AP 311 and STA 313 may exchange frames during first TWT SP 321-1. STA 313 may enter a doze state at the end of first TWT SP 321-1 and may remain in the doze state until the start of second TWT SP 321-2. The start of second TWT SP 321-2 may be indicated by a TWT wake interval 331 associated with TWT SP 321. AP 311 and STA 313 may again exchange frames during second TWT SP 31-2.

In an awake state, a STA may be fully powered. The STA may transmit and/or receive a frame to/from an AP or another STA. In a doze state, a STA may not transmit and may not receive a frame to/from an AP or another STA.

An MLD is an entity capable of managing communication over multiple links. The MLD may be a logical entity and may have more than one affiliated station (STA). The MLD may have a single MAC service access point (MAC-SAP) to the LLC layer, which includes a MAC data service. An MLD may be an access point MLD (AP MLD) when a STA affiliated with the MLD is an AP STA (or an AP). An MLD may be a non-access point MLD (non-AP MLD) or STA MLD when a STA affiliated with the MLD is a non-AP STA (or a STA).

During negotiation of TWT agreements, a TWT requesting STA affiliated with a STA MLD and a TWT responding STA affiliated with an AP MLD may communicate multiple TWT elements. The TWT elements may comprise link ID bitmap subfields indicating different link(s) in a TWT setup frame. The TWT parameters provided by a TWT element may be applied to the respective link that is indicated in the TWT element.

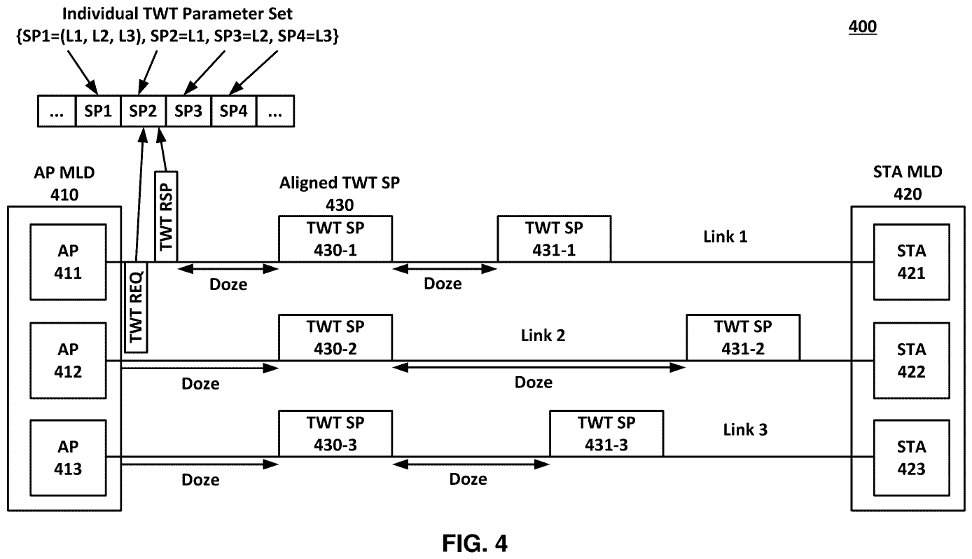

FIG. 4 illustrates an example 400 of TWT operation in a multi-link environment including an AP multi-link device (AP MLD) 410 and a STA multi-link device (STA MLD) 420. As shown in FIG. 4, AP MLD 410 may have three affiliated APs, AP 411, AP 2 412, and AP 3 413. In an example, AP 411, AP 2 412, and AP 3 413 may operate respectively on the 2.4 GHz band, the 5 GHz band, and the 6 GHz band. STA MLD 420 may have three affiliated STAs, STA 421, STA 422, and STA 423. In an example, STA 421, STA 422, and STA 423 may operate respectively on the 2.4 GHz band, the 5 GHz band, and the 6 GHz band. In an example, AP 411, AP 2 412, and AP 3 413 may be communicatively coupled via a first link (link 1), a second link (link 2), and a third link (link 3) respectively with STA 421, STA 422, and STA 423, respectively.

In an example, STA 421 may transmit a TWT request to AP 411. The TWT request may include three TWT elements. Each TWT element may indicate a respective link of links 1-3 and may request the setup of a TWT agreement for the indicated link. The three TWT elements may have different TWT parameters, such as target wake time (TWT). In response to the TWT request, AP 411 may transmit a TWT response to STA 421. The TWT response may include three TWT elements. Each TWT element may indicate a respective link of links 1-3 and may include a value of ‘accept TWT’ in a TWT setup command field.

Successful TWT agreement setup on links 1-3 establishes three TWT SPs with same or different TWT parameters on links 1-3 respectively. The target wake time field of the TWT element indicating a given link indicates the start time of the TWP SP for that link. The starting time may be indicated in reference to a time synchronization function (TSF) time of the link.

In example 400, initial TWT SPs 430-1, 430-2, and 430-3 of links 1-3 respectively may be aligned. TWT wake intervals associated with the TWT agreements of links 1-3 respectively may be set differently. As such, second TWT SPs 431-1, 431-2, and 431-3 of links 1-3 respectively may not be aligned. STA 421, STA 422, and STA 423 may enter a doze state between the end of initial TWT SPs 430-1, 430-2, and 430-3, respectively, and the start of second TWT SPs 431-1, 431-2, 431-3, respectively.

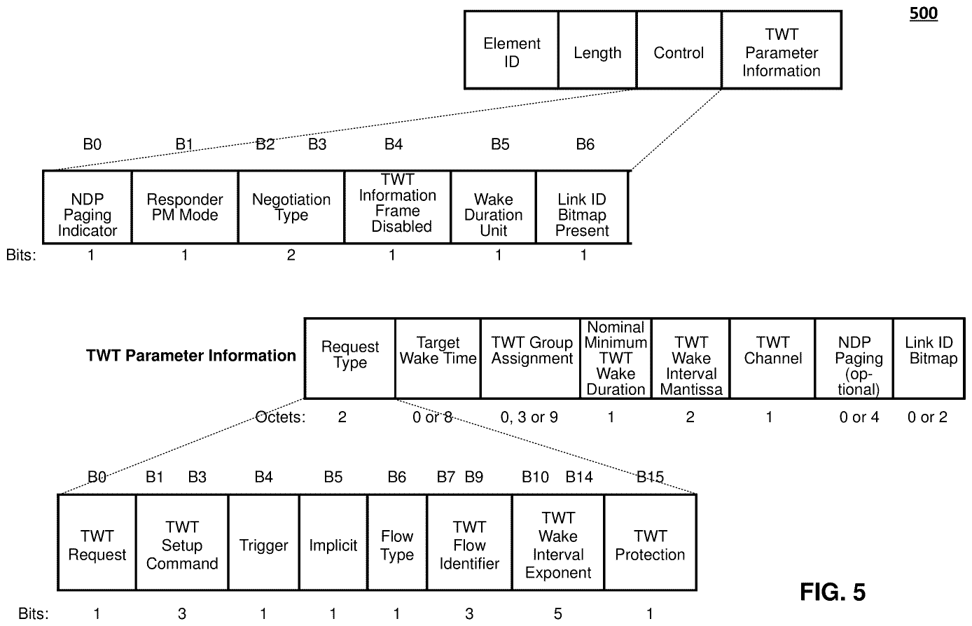

FIG. 5 illustrates an example target wake time (TWT) element 500 which may be used to support individual TWT operation.

In an example, an AP and a STA may use TWT element 500 to negotiate a TWT agreement. The AP and/or the STA may transmit TWT element 500 in an individually addressed management frame. The management frame may be of the type action, action no ack, (re)association request/response, and probe request response, for example.

The TWT schedule and parameters may be provided during a TWT setup phase. Renegotiation/changes of TWT schedules may be signaled via individually addressed frames that contain the updated TWT schedule/parameters. The frames may be management frames as described above or control or data frames that carry a field containing the updated TWT schedule/parameters.

Referring to FIG. 5, TWT element 500 includes an element ID field, a length field, a control field, and a TWT parameter information field.

The element ID field (e.g., 1 octet in length) may indicate that information element 500 is a TWT element. The length field (e.g., 1 octet) may indicate the length of TWT element 500 starting from the control field until an end of TWT element 500. The end of TWT element 500 may be the end of a TWT Channel field or the end of a Link ID bitmap field of the TWT parameter information field.

The TWT parameter information field may include a request type field (e.g., 2 octets), a target wake time field (e.g., 8 octets or less), a TWT group assignment field (e.g., 9, 3, 2, or 0 octets), a nominal minimal TWT wake duration field (e.g., 1 octet), a TWT wake interval mantissa (e.g., 2 octets), a TWT channel field (e.g., 1 octet), an optional NDP paging field (e.g., 0 or 4 octets), and/or a Link ID bitmaps field (e.g., 0 or 2 Octets).

The request type field may indicate a type of TWT request. The request type field may include a TWT request field (e.g., 1 bit), a TWT setup command field (e.g., 3 bits), a trigger field (e.g., 1 bit), an implicit field (e.g., 1 bit), a flow type (e.g., 1 bit), a TWT flow identifier (e.g., 3 bits), a TWT wake interval exponent (e.g., 5 bits), and/or a TWT protection field (e.g., 1 bit).

The TWT request field may indicate whether the TWT element 500 represents a request. If TWT request field has a value of 1, then the TWT element 500 may represent a request to initiate TWT scheduling/setup.

The TWT setup command field may indicate a type of TWT command. In a TWT request, the type of TWT command indicated may be: a request TWT (the TWT responding STA specifies the TWT value; e.g., field set to 0), a suggest TWT (the TWT requesting STA suggests a TWT value; e.g., field set to 1), and a demand TWT (the TWT requesting STA demands a TWT value; e.g., field set to 2).

In a TWT response, the type of TWT command indicated may be: TWT grouping (the TWT responding STA suggests TWT group parameters that are different than the suggested or demanded TWT parameters of the TWT requesting STA; e.g., field set to 3), accept TWT (the TWT responding STA accepts the TWT request with the TWT parameters indicated by the TWT requesting STA; e.g. field set to 4), alternate TWT (the TWT responding STA suggests TWT parameters that are different than the parameters suggested or demanded by the TWT requesting STA; e.g., field set to 5), dictate TWT (the TWT responding STA demands TWT parameters that are different than the parameters suggested or demanded by the TWT requesting STA; e.g., field set to 6), or reject TWT (the TWT responding STA rejects the TWT setup; e.g. field set to 7).

In a TWT response, the TWT command may also indicate an unsolicited response or a broadcast TWT. An unsolicited TWT response is an individually addressed frame that is intended for a specific STA. An unsolicited TWT response may be followed by an ACK frame from the STA receiving the unsolicited TWT response. A broadcast TWT may be intended for multiple STAs and may be carried in a broadcast frame such as, for example, a beacon frame. A broadcast TWT may not be acknowledged by receiving STAs.

An unsolicited TWT response may be used a TWT responding STA to demand that a recipient follow a TWT schedule contained in the TWT element. In an embodiment, an unsolicited TWT response may have the TWT request field set to 0 and a value of ‘dictate TWT’ in the TWT setup command field. A broadcast TWT response may be used by a TWT responding STA to schedule a TWT for any STA that receives and decodes the TWT element.

In certain embodiments, a TWT element, such as TWT element 500, may contain TWT parameter sets for multiple TWT negotiations or indications as described herein. As such, the TWT element may include multiple instances of the Control and the TWT parameter information fields. The TWT flow identifier of the request type field indicates the TWT negotiation which parameters are carried by the TWT parameter information field.

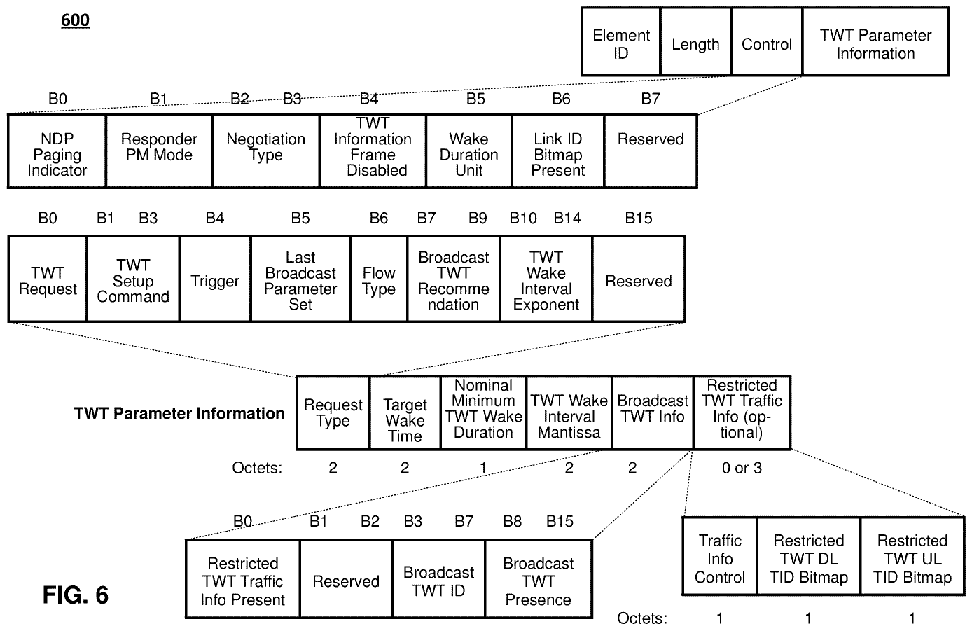

FIG. 6 illustrates an example target wake time (TWT) element 600 which may be used to support restricted TWT (r-TWT) operation. For r-TWT, TWT element 600 may be transmitted in a broadcast management frame, which can be a beacon frame, a TIM broadcast frame, a probe response frame, etc. In this embodiment, TWT element 600 provides non-negotiated TWT schedules (e.g., broadcast TWT schedules).

As shown, TWT element 600 includes an element ID field, a length field, a control field, and a TWT parameter information field.

The element ID field (e.g., 1 octet in length) may indicate that information element 600 is a TWT element. The length field (e.g., 1 octet) may indicate the length of TWT element 600 starting from the control field until an end of TWT element 600. The end of TWT element 600 may be the end of a broadcast TWT info field or the end of a r-TWT traffic info field of the TWT parameter information field.

The TWT parameter information field may include a request type field, a target wake time field (e.g., 2 octets), a nominal minimal TWT wake duration field (e.g., 1 octet), a TWT wake interval mantissa (e.g., 2 octets), a broadcast TWT info field (e.g., 2 octets), and an optional r-TWT traffic info field (e.g., 0 or 3 octets).

The request type field may include, among other fields, a TWT request field, a flow type field, and a TWT wake interval exponent field.

The TWT request field indicates whether TWT element 600 is a request. If the TWT request field has a value of 0, then TWT element 600 may represent a response to a request to initiate TWT scheduling/setup (solicit TWT), an unsolicited TWT response, and/or a broadcast TWT message.

The TWT wake interval represents the average time that a TWT requesting STA or a TWT scheduled STA expects to elapse between successive TWT SP start times of a TWT schedule. The TWT wake interval exponent field indicates a (base 2) exponent used to calculate the TWT wake interval in microseconds. In an embodiment, the TWT wake interval is equal to: (TWT wake interval mantissa)×2^{(TWT Wake Interval Exponent)}. The TWT wake interval mantissa value is indicated in microseconds, base 2 in a TWT wake interval mantissa field of the TWT parameter information field.

The nominal minimum TWT wake duration field may indicate the minimum amount of time (in the unit indicated by a wake duration unit subfield of the control field) that a TWT requesting STA or a TWT scheduled STA is expected to be awake to complete frame exchanges for the period of the TWT wake interval.

The flow type field, in a TWT response that successfully set up a TWT agreement between a TWT requesting STA and a TWT responding STA, may indicate a type of interaction between the TWT requesting STA and the TWT responding STA within a TWT SP of the TWT agreement. A flow type field equal to 0 may indicate an announced TWT. In an announced TWT, the TWT responding STA may not transmit a frame to the TWT requesting STA within a TWT SP until the TWT responding STA receives a PS-Poll frame or a QoS Null frame from the TWT requesting STA. A flow type field equal to 1 may indicate an unannounced TWT. In an unannounced TWT, the TWT responding STA may transmit a frame to the TWT requesting STA within a TWT SP before it has received a frame from the TWT requesting STA.

Within a TWT element that includes a TWT setup command value of ‘request TWT’, ‘suggest TWT’, or ‘demand TWT’, a broadcast TWT ID may indicate a specific broadcast TWT in which the TWT requesting STA is requesting to participate. Within a TWT element that includes a TWT setup command value of ‘accept TWT’, ‘alternate TWT’, ‘dictate TWT’, or ‘reject TWT’, a broadcast TWT ID may indicate a specific broadcast TWT for which the TWT responding STA is providing TWT parameters. The value 0 in the broadcast TWT ID subfield may indicate the broadcast TWT whose membership corresponds to all STAs that are members of the BSS corresponding to the BSSID of the management frame carrying the TWT element and that is permitted to contain trigger frames with random access resource units for unassociated STAs. The Broadcast TWT ID subfield in a r-TWT Parameter set field is always set to a nonzero value.

A broadcast TWT element 600 that contains a r-TWT parameter set is also referred to as a r-TWT element. A r-TWT traffic info present subfield of the broadcast TWT info field may be set to 1 to indicate the presence of the r-TWT traffic info field in TWT element 600. The r-TWT traffic info field is present in a r-TWT parameter set field when the r-TWT traffic info present subfield is set to 1.

The r-TWT traffic info field may include a traffic info control field, a r-TWT DL TID bitmap field, and a r-TWT UL TID bitmap field.

The traffic info control field may include a DL TID bitmap valid subfield and an UL TID bitmap valid subfield. The DL TID bitmap valid subfield indicates if the r-TWT DL TID bitmap field has valid information. When the value of the DL TID bitmap valid subfield is set to 0, it may indicate that DL traffic of TIDs is identified as latency sensitive traffic, and the r-TWT DL TID bitmap field is reserved. The UL TID bitmap valid subfield may indicate if the r-TWT UL TID bitmap field has valid information. When the value of the UL TID bitmap valid subfield is set to 0, it may indicate that UL traffic of TIDs is identified as latency sensitive traffic, and the r-TWT UL TID bitmap field is reserved.

The r-TWT DL TID bitmap subfield and the r-TWT UL TID bitmap subfield may specify which TID(s) are identified by the TWT scheduling AP or the TWT scheduled STA as latency sensitive traffic streams in a downlink and a uplink direction, respectively. A value of 1 at bit position k in the bitmap indicates that TID k is classified as a latency sensitive traffic stream. A value of 0 at bit position k in the bitmap indicates that TID k is not classified as a latency sensitive traffic stream.

An individual target wake time (TWT) may be a specific time or set of times negotiated between two individual stations (e.g., a STA and another STA, or a STA and an AP, etc.) at which the stations may be awake to exchange frames during a service period (SP) of the TWT.

In trigger-enabled TWT, an AP may transmit a trigger frame for scheduling uplink multi-user transmissions from one or more STAs using uplink OFDMA (orthogonal frequency division multiple access) and/or uplink MU-MIMO (multi-user multiple input multiple output) during a trigger-enabled TWT SP. A TWT STA that receives the trigger frame from the AP may transmit a frame to the AP through a resource indicated in the trigger frame during the trigger-enabled TWT SP.

In non-trigger-enabled TWT, an AP may not be required to transmit a trigger frame to schedule uplink multi-user transmissions from one or more STAs during a non-trigger-enabled TWT SP.

In announced TWT, a STA may transmit a frame (e.g., a PS-Poll frame or a QoS null frame) to the AP to retrieve a downlink buffered data from the AP during a TWT SP. In unannounced TWT, an AP may transmit downlink data to a TWT STA without receiving a frame (e.g., a PS-Poll frame, or a QoS null frame) from the TWT STA during a TWT SP.

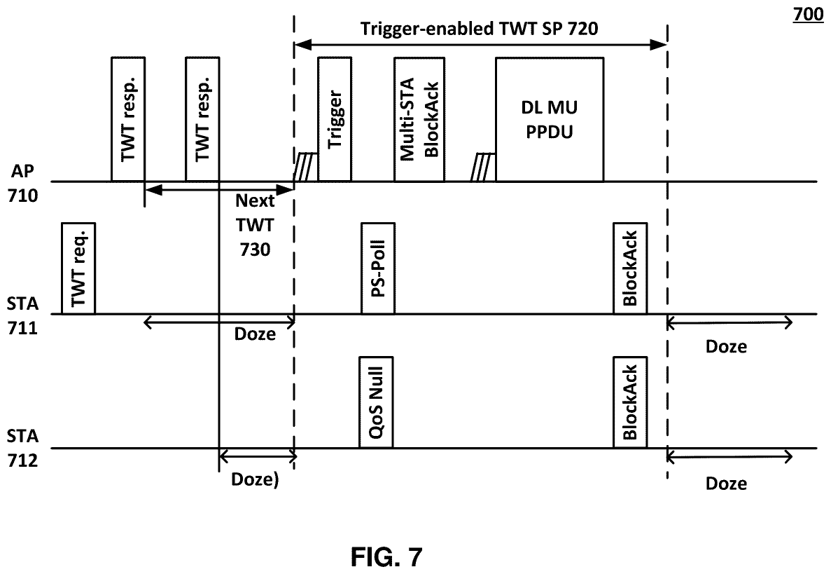

FIG. 7 illustrates an example 700 of individual TWT operation. As shown in FIG. 7, example 700 includes an AP 710, a STA 711, and a STA 712. In an example, AP 710 may be a TWT responding STA and STA 711 and STA 712 may be TWT requesting STAs.

In an example, STA 711 may transmit a TWT request to AP 710 to setup a first trigger-enabled TWT agreement. STA 711 may set a trigger field of the TWT request to 1 to indicate that it is requesting a trigger-enabled TWT. AP 710 may accept the first TWT agreement with STA 711. AP 710 may confirm the acceptance in a TWT response sent to STA 711. The TWT response may indicate a next TWT 730, which indicates the time until a next TWT SP 720 according to the first TWT agreement.

In an example, AP 710 may transmit an unsolicited TWT response to STA 712 to set up a second trigger-enabled TWT agreement with STA 712 without receiving a TWT request from STA 712. The first and second TWT agreements may be set up as announced TWTs.

After the setup of the TWT agreements, STA 711 and STA 712 may enter a doze state until the start of TWT SP 720. During trigger-enabled TWT SP 720, AP 710 may transmit a trigger frame. STA 711 and STA 12 may respond to the trigger frame by indicating that they are in awake state. In an example, STA 711 may transmit a power save poll (PS-Poll) frame. The PS-Poll frame may comprise a BSSID (receiver address: RA) field set to an address of AP 710 and a transmitter address (TA) field set to an address of STA 711. In an example, STA 712 may transmit a QoS null frame in response to the trigger frame. The QoS null frame may comprise a MAC header (e.g., a frame control field, a duration field, address fields, a sequence control field, QoS control field) without a frame body.

In response to the PS-Poll frame and the QoS null frame, AP 710 may transmit a multi-STA Block Ack (M-BA) frame. The M-BA frame may include acknowledgement information associated with the PS-Poll frame and the QoS null frame received from STAs 711 and 712 respectively. Subsequently, STA 711 and STA 712 may receive downlink bufferable units (DL BUs) from AP 710. The DL BUs may include a medium access control (MAC) service data unit (MSDU), an aggregate MAC service data unit (A-MSDU), and/or a bufferable MAC management protocol data unit (MMPDU). STA 711 and STA 712 may transmit BlockAck (BA) frames in response to the DL BUs. At the end of the TWT SP 720, STA 711 and STA 712 may return to a doze state.

A STA may execute individual TWT setup exchanges. The STA may not transmit frames to an AP outside of negotiated TWT SPs. The STA may not transmit frames that are not contained within high efficiency trigger-based physical protocol data units (HE TB PPDUs) to the AP within trigger-enabled TWT SPs. A HE TB PPDU may be transmitted by a STA based on receiving a trigger frame triggering uplink multi-user transmissions.

The AP of a trigger-enabled TWT agreement may schedule for transmission a trigger frame for a STA within the trigger-enabled TWT SP. The STA may transmit an HE TB PPDU as a response to the trigger frame sent during the trigger-enabled TWT SP. A STA that is in power save (PS) mode may include a PS-Poll frame or a QoS null frame in the HE TB PPDU if the TWT is an announced TWT, to indicate to the AP that the STA is currently in the awake state. The AP that receives the PS-Poll frame or the QoS Null frame or any other indication from an STA in PS mode, may deliver to the STA as many buffered BUs as are available at the AP during the TWT SP.

A broadcast target wake time (TWT) may be a specific time or set of times broadcast by an AP to one or more STAs at which the STAs may be awake to exchange frames with the AP during a SP of the TWT.

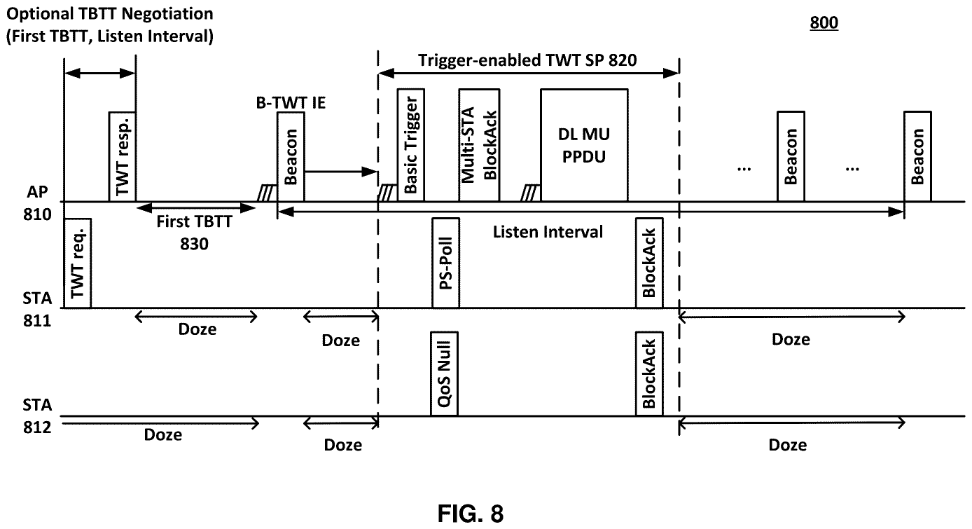

FIG. 8 illustrates an example 800 of broadcast TWT operation. As shown in FIG. 8, example 800 includes an AP 810, a STA 811, and a STA 812. In an example 800, AP 810 may be a TWT scheduling AP and STA 811 and STA 812 may be TWT scheduled STAs.

In an example, AP 810 may include a broadcast TWT element in a beacon frame that indicates a broadcast TWT SP 820. During the broadcast TWT SP 820, AP 810 may transmit trigger frames or DL BUs to STA 811 and STA 812. Beacon frames may be sent by AP 810 periodically at target beacon transmission times (TBTTs). The number of time units (TUs) between consecutive TBTTs is called the beacon interval. A TU is equal to 1024 microseconds.

In an example, STA 811 and STA 812 may enter a doze state until the first target beacon transmission time (TBTT). STA 811 and STA 812 may wake up to receive the beacon frame at the first TBTT to determine the broadcast TWT. Upon reception of a broadcast TWT element in a beacon frame, STA 811 and STA 812 may re-enter the doze state until the start of trigger-enabled TWT SP 820.

During trigger-enabled TWT SP 820, AP 810 may transmit a basic trigger frame to STA 811 and STA 812. STA 811 may indicate that it is awake by transmitting a PS-Poll, and STA 812 may indicate that it is awake by transmitting a QoS null frame in response to the basic trigger frame. Subsequently, STA 811 and STA 812 may receive DL BUs from AP 810. STA 811 and STA 812 may return to the doze state outside of the TWT SP 720.

In an example, a STA that intends to operate in power save mode may negotiate a wake TBTT and a wake interval with the AP. For example, as shown in FIG. 8, STA 811 may transmit a TWT request to AP 810 that identifies a wake TBTT of the first beacon frame and a wake interval between subsequent beacon frames. AP 810 may respond with a TWT response to the TWT request confirming the wake TBTT and wake interval. After successfully completing the negotiation, STA 811 may enter a doze state until a first negotiated wake TBTT 830. STA 811 may be in an awake state to listen to the beacon frame transmitted at first negotiated wake TBTT 830. If STA 811 receives a beacon frame from AP 810 at or after TBTT 830, STA 811 may return to the doze state until the next wake TBTT unless a traffic indication map (TIM) element in a beacon frame includes a positive indication for STA 811. The STA 811 may return to the doze state after a nominal minimum TBTT wake duration time has elapsed from the TBTT start time.

A Network Allocation Vector (NAV) is an indicator, maintained by a station (STA), of time periods when transmission onto the wireless medium (WM) may not be initiated by the STA regardless of whether the clear channel assessment (CCA) function of the STA senses that the WM is busy. A STA that receives at least one valid frame in a PSDU may update its NAV with the information from any valid duration field in the PSDU. The STA may update the NAV when a value of the received duration field is greater than the current NAV value of the STA.

A TWT protection is a mechanism employed to protect a TWT session from external STA transmissions. During a TWT SP configured to protect the TWT session, a STA that initiates a transmission opportunity (TXOP) to transmit a frame may transmit a request to transmit (RTS) frame or a clear to transmit (CTS) frame to protect the TWT session by setting the NAV of other STAs based on receiving of the RTS frame and/or the CTS frame. The RTS frame may comprise a frame control field, a duration field, a receiver address (RA) field, a transmitter address (TA) field, and a frame check sequence (FCS) field. The CTS frame may comprise a frame control field, a duration field, a receiver address (RA) field, and a frame check sequence (FCS) field.

The TWT protection field in a TWT element may indicate whether a TWT is protected or unprotected. A TWT requesting STA may set the TWT protection field to 1 to request the TWT responding STA to provide protection for the set of TWT SPs. A TWT protection field equal to 1 may indicate to use a NAV protection mechanism to protect access to the medium during the corresponding TWT SPs.

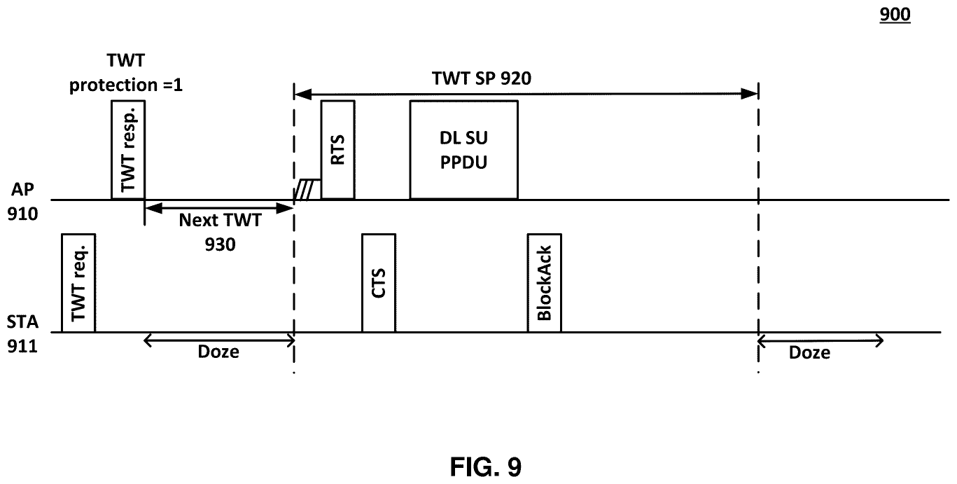

FIG. 9 illustrates an example 900 of TWT protection in individual TWT operation. As shown in FIG. 9, example 900 includes an AP 910 and a STA 911.

In an example, AP 910 may set the TWT protection field to 1 in a TWT response frame to protect the TWT SPs using a NAV protection mechanism. Upon reception of the TWT response frame, STA 911 may enter a doze state until the next TWT 930. AP 910 that has set the TWT protection field to 1 may transmit a NAV setting frame at the start of the TWT SP 920. For example, the NAV setting frame may be an RTS frame or a CTS frame.

A STA that receives the NV setting frame and that is not scheduled to access the medium during the TWT SP 920 may set their NAV according to the NAV setting frame. The STA may not access the medium for the specified amount of time in the NAV setting frame.

STA 911 may be scheduled to access the medium during the TWT SP 920. STA 911 may respond to the RTS frame with a CTS frame. Upon receiving the CTS frame, AP 910 may transmit a downlink frame to STA 911. STA 911 may respond to the downlink frame with a BA frame. When the TWT SP 920 ends, STA 911 may return to the doze state.

Triggered TXOP sharing (TXS) is a technique introduced in the IEEE 802.11be standard amendment. TXS allows an AP to allocate a time duration within an obtained TXOP to a STA for transmitting one or more non-trigger-based (non-TB) PPDUs. For the TXS procedure, the AP may transmit a multi-user request-to-send (MU-RTS) trigger frame with a triggered TXOP sharing mode subfield set to a non-zero value. The MU-RTS trigger frame is a trigger frame for triggering CTS frame(s) from multiple users. An MU-RTS trigger frame with the triggered TXOP sharing mode subfield set to a non-zero value is called an MU-RTS TXS trigger (MRTT) frame.

In an example, when the triggered TXOP sharing mode subfield is set to 1, the STA may transmit the one or more non-TB PPDUs to the AP during the allocated time duration. In an example, when the triggered TXOP sharing mode subfield is set to 2, the STA may transmit the one or more non-TB PPDUs to the AP or a peer STA during the allocated time duration. The peer STA may be a STA with a connection for peer-to-peer (P2P) communication or direct communication with the STA. In an example, the direct wireless link is established according to the tunneled direct link setup (TDLS) protocol.

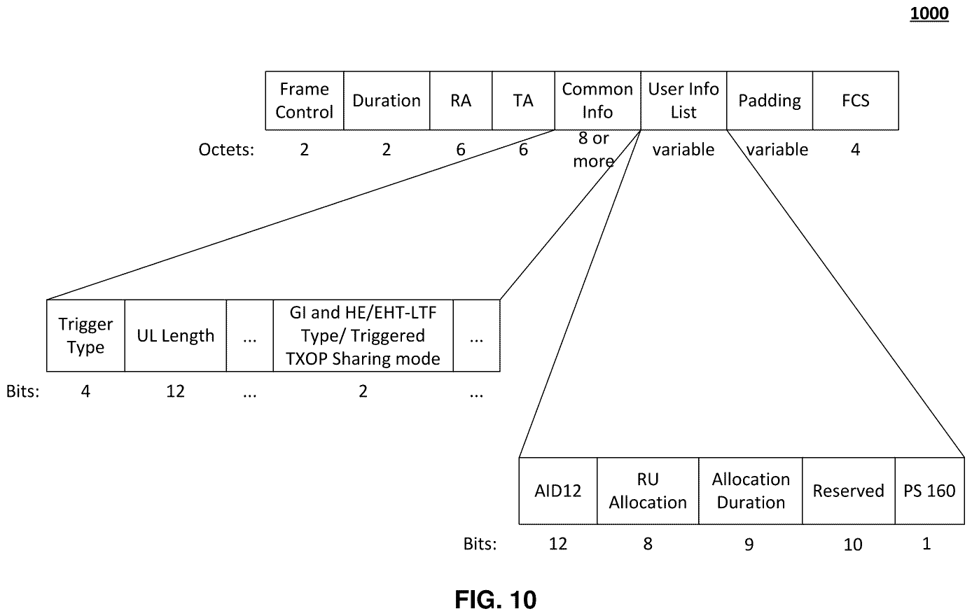

FIG. 10 illustrates an example MRTT frame 1000 which may be used in a TXS procedure. As shown in FIG. 10, example MRTT frame 1000 may comprise a frame control field, a duration field, a receiver address (RA) field, a transmitter address (TA) field, a common info field, a user info list field, a padding field, and/or frame check sequence (FCS) field.

In an example, the common info field may be a high-efficiency (HE) variant common info field or an extremely high throughput (EHT) variant common info field. An EHT variant common info field may comprise, as shown in FIG. 10, one or more of the following subfields: trigger type, UL length, more TF, CS required, UL BW, GI and HE/EHT-LTF Type/Triggered TXOP sharing mode, number of HE/EHT-LTF symbols, LDPC extra symbol segment, AP Tx Power, Pre-FEC padding factor, PE disambiguity, UL spatial reuse, HE/EHT P160, special user info field flag, EHT reserved, reserved, or trigger dependent common info.

The trigger type subfield indicates that frame 1000 is an MRTT frame.

The GI and HE/EHT-LTF Type/Triggered TXOP sharing mode subfield may include a triggered TXOP sharing mode subfield. In an example, the triggered TXOP sharing mode subfield may be set to a non-zero value (e.g., 1 or 2). In an example, the triggered TXOP sharing mode subfield may be set to 1. As such, the triggered TXOP sharing mode subfield may indicate that a STA indicated by an AID12 subfield of a user info field (of the user info list field) may transmit one or more non-TB PPDUs to the AP during a time indicated in the allocation duration subfield of the user info field. In another example, the triggered TXOP sharing mode subfield may be set to 2. As such, the triggered TXOP sharing mode subfield may indicate that a STA indicated by an AID12 subfield of a user info field (of the user info list field) may transmit one or more non-TB PPDUs to the AP or to a peer STA during the time indicated by the allocation duration subfield of the user info field. In an example, the peer STA may be a STA with a connection for P2P communication or direct communication with the STA.

The user info list field may include one or more user info fields. In an example, an EHT variant user info field may comprise, as shown in FIG. 10, one or more of the following subfields: AID12, RU allocation, allocation duration, reserved, or PS160.

The AID12 subfield may indicate an association identifier (AID) of a STA that may use a time indicated by the allocation duration subfield.

The RU allocation subfield may indicate the location and size of the RU allocated for a STA indicated by the AID12 subfield.

The allocation duration subfield may indicate a time allocated by an AP transmitting MRTT frame 1000. The allocated time may be a portion a TXOP obtained by the AP. In an example embodiment, the allocation duration subfield may indicate a first time period.

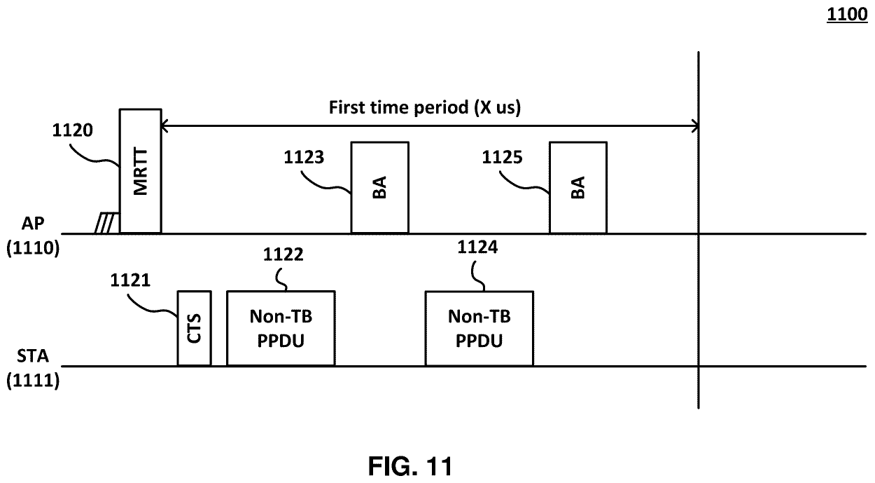

FIG. 11 illustrates an example 1100 of a TXS procedure (Mode=1). As shown in FIG. 11, the TXS procedure may begin by an AP 1110 transmitting an MRTT frame 1120 to a STA 1111. MRTT frame 1120 may allocate a portion of a TXOP obtained by AP 1110 to STA 1111 and may indicate a TXS mode equal to 1. STA 1111 receiving MRTT frame 1120 may use the allocated time to transmit one or more non-TB PPDUs to AP 1110. The one or more non-TB PPDUs may comprise a data frame, a control frame, a management frame, or an action frame.

In an example, MRTT frame 1120 may comprise a triggered TXOP sharing mode subfield that indicates the TXS mode and/or subfield that indicates a first time period corresponding to the allocated time. In an example, the first time period may be set to a value of X microseconds (us).

STA 1111 may respond to MRTT frame 1120 by transmitting a CTS frame 1121 to AP 1110. Subsequently, STA 1111 may transmit non-TB PPDUs 1122, 1124 comprising one or more data frame to AP 1110 during the first time period indicated in MRTT frame 1120. In an example, AP 1110 may transmit one or more BA frames 1123, 1125 in response to the one or more data frames contained in non-TB PPDUs 1122, 1124 received from STA 1111.

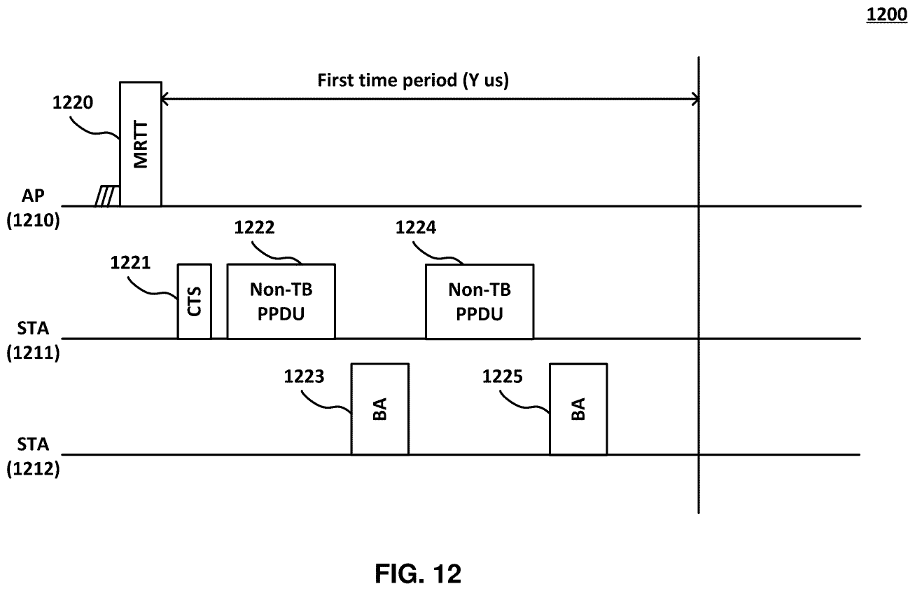

FIG. 12 illustrates an example 1200 of a TXS procedure (Mode=2). As shown in FIG. 12, the TXS procedure may begin by an AP 1210 transmitting an MRTT frame 1220 to a STA 1211. MRTT frame 1220 may allocate a portion of a TXOP obtained by AP 1210 to STA 1211 and may indicate a TXS mode equal to 2. STA 1211 receiving MRTT frame 1220 may use the allocated time to transmit one or more non-TB PPDUs to STA 1212. The one or more non-TB PPDUs may comprise a data frame, a control frame, a management frame, or an action frame.

In an example, MRTT frame 1220 may comprise a triggered TXOP sharing mode subfield that indicates the TXS mode and/or subfield that indicates a first time period corresponding to the allocated time. In an example, the first time period may be set to a value of X microseconds (us).

STA 1211 may respond to MRTT frame 1220 by transmitting a CTS frame 1221 to AP 1210. Subsequently, STA 1211 may transmit non-TB PPDUs 1222, 1224 comprising one or more data frame to STA 1212 during the first time period indicated in MRTT frame 1220. In an example, STA 1212 may transmit one or more BA frames 1223, 1225 in response to the one or more data frames contained in non-TB PPDUs 1222, 1224 received from STA 1211.

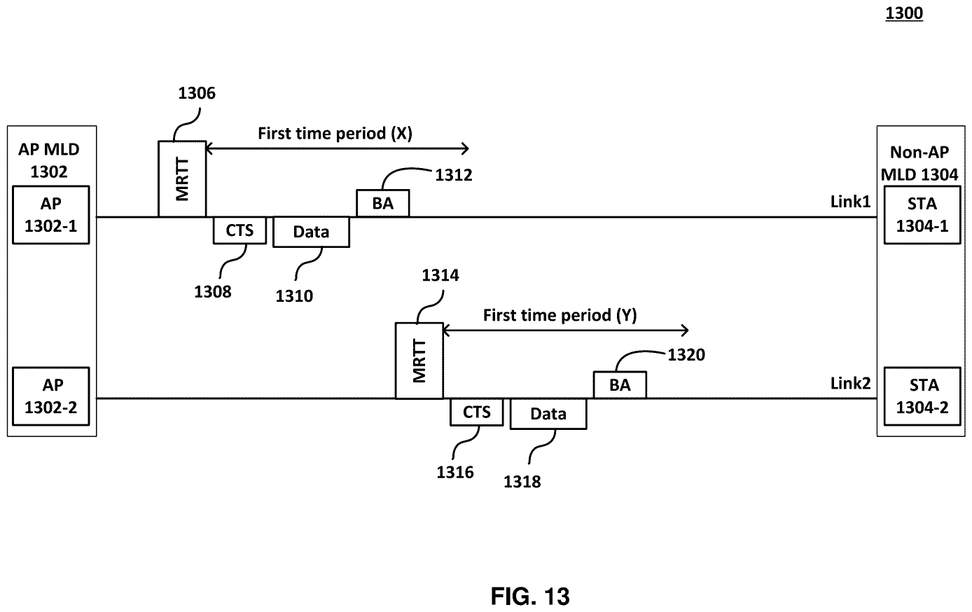

FIG. 13 is an example 1300 that illustrates an example TXS procedure between multi-link devices (MLDs). As shown in FIG. 13, example 1300 includes an AP MLD 1302 and a non-AP MLD 1304. An AP 1302-1 and an AP 1302-2 may be affiliated with AP MLD 1302. A STA 1304-1 and a STA 1304-2 may be affiliated with non-AP MLD 1304. STA 1304-1 may be associated with AP 1302-1. AP 1302-1 and STA 1304-1 may communicate over a first link (link 1). STA 1304-2 may be associated with AP 1302-2. AP 1302-2 and STA 1304-2 may communicate over a second link (link 2).

In an example, AP 1302-1 may transmit an MU-RTS TXS Trigger (MRTT) frame 1306 to STA 1304-1 on link 1. MRTT frame 1306 may comprise a TXOP sharing mode subfield set to 1, an AID 12 subfield set to an AID of STA 1304-1, and/or a first time period (e.g., X us, where X is an integer value larger than 0).

In an example, STA 1304-1 may transmit a CTS frame 1308 in response to MRTT frame 1306 on link 1. Subsequently, STA 1304-1 may transmit a data frame 1310 (e.g., in a non-TB PPDU) to AP 1302-1 on link 1 during the first time period. AP 1302-1 may transmit a BA frame 1313 in response to data frame 1310 on link 1 during the first time period.

In an example, AP 1302-2 may transmit an MRTT frame 1314 to STA 1304-2 on link 2. MRTT frame 1314 may comprise a TXOP sharing mode subfield set to 1, an AID 12 subfield set to an AID of STA 1304-2, and/or a first time period (e.g., Y us, where Y is an integer value larger than 0).

In an example, STA 1304-2 may transmit a CTS frame 1316 in response to MRTT frame 1314 on link 2. Subsequently, STA 1304-2 may transmit a data frame 1318 (e.g., in a non-TB PPDU) to AP 1302-2 on link 2 during the first time period. AP 1302-2 may transmit a BA frame 1320 in response to data frame 1318 on link 2 during the first time period (e.g., Y us).

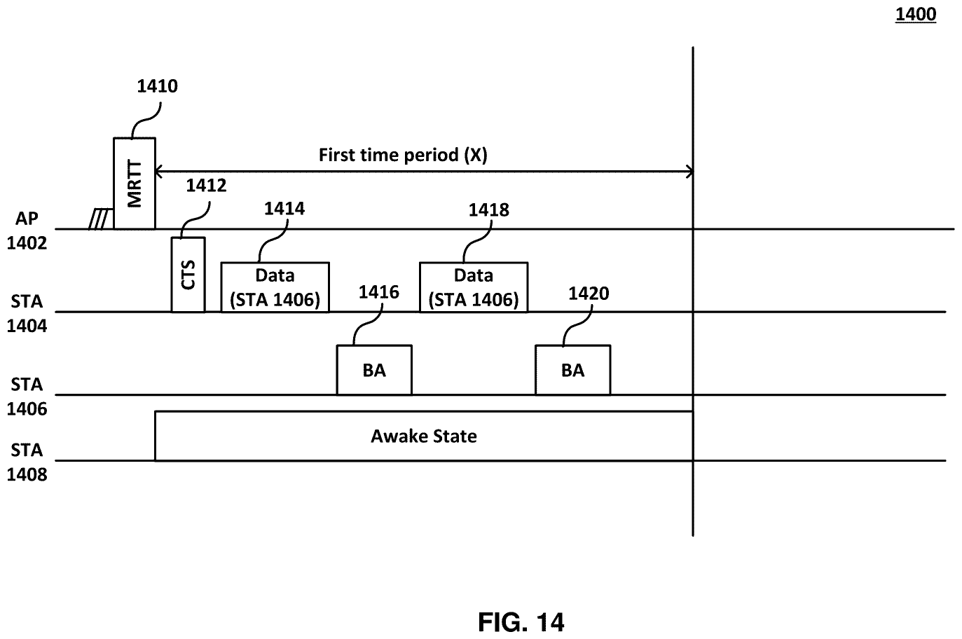

FIG. 14 is an example 1400 that illustrates an inefficient STA operation that may occur during a TXS procedure. As shown in FIG. 14, example 1400 includes an AP 1402 and STAs 1404, 1406, and 1408. STA 1404 may be associated with AP 1402.

In an example, AP 1402 may allocate a portion of an obtained TXOP to STA 1404 by transmitting an MRTT frame 1410. STA 1404 may transmit a CTS frame 1412 to AP 1402 in response to MRTT frame 1410.

MRTT frame 1410 may comprise a TXOP sharing mode subfield, an AID 12 subfield set to an AID of STA 1404, and/or a first time period (e.g., X us).

In an example, the first time period may indicate a portion of time allocated by AP 1402 within an obtained TXOP. In an example, the first time period may be indicated by a subfield (e.g., an allocation duration field) in MRTT frame 1410. In an example, the first time period may be set to a value of X us.

In an example, the TXOP sharing mode subfield is set to 2. The TXOP sharing mode subfield set to 2 indicates that STA 1404 may transmit one or more non-TB PPDUs to AP 1402 or to a peer STA during the first time period. In an example, the peer STA may be a STA having a connection for P2P communication or direct communication with STA 1404. In an example, the peer STA may be STA 1406. The one or more non-TB PPDUs may comprise a data frame, a control frame, a management frame, or an action frame. In example 1400, STA 1404 may transmit a data frame 1414 to STA 1406 during the first time period. STA 1406 may transmit a BA frame 1416 to STA 1404 in response to data frame 1414. STA 1404 may then transmit a data frame 1418 to STA 1406. STA 1406 may respond to data frame 1418 with a BA frame 1420.

After receiving MRTT frame 1410, STA 1408 may be in an awake state during the first time period (X) indicated in MRTT frame 1410. However, during this first time period, AP 1402 may not communicate with STA 1408 as STA 1408 is not allocated by MRTT frame 1410. The awake power state of STA 1408 may thus result in power being unnecessarily wasted at STA 1408.

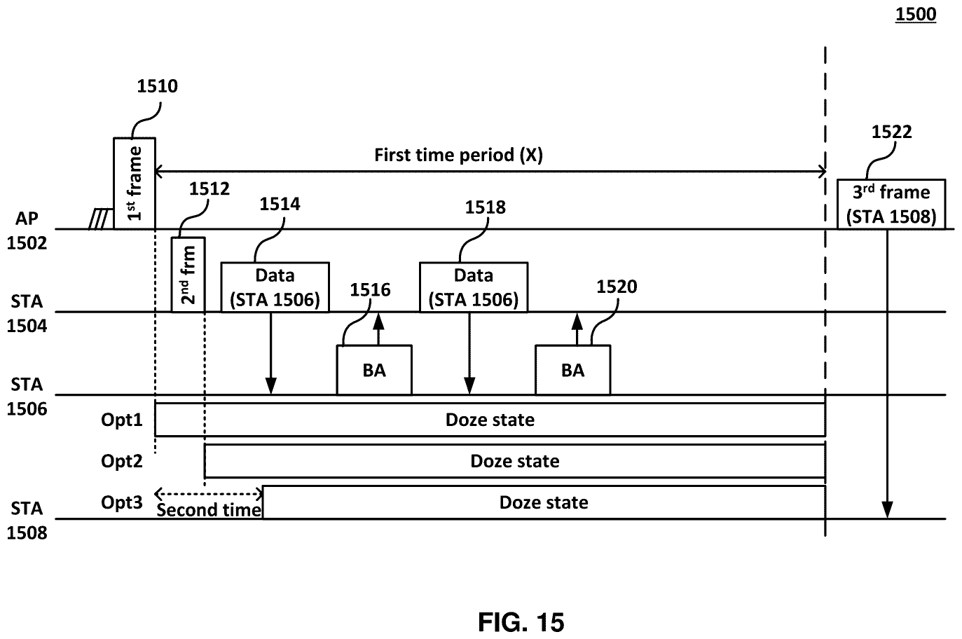

FIG. 15 is an example 1500 that illustrates an example TXS PS (PS) mode that may be used to address this problem. As shown in FIG. 15, example 1500 includes an AP 1502 and STAs 1504, 1506, and 1508. One or more of STAs 1504, 1506, and 1508 may be associated with AP 1502.

As shown in FIG. 15, example 1500 may begin with AP 1502 transmitting a first frame 1510 to allocate a portion of an obtained TXOP to STA 1504. Frame 1510 may comprise a TXOP sharing mode subfield, an AID 12 subfield, and a first time period (e.g., X us). The TXOP sharing mode subfield may indicate a triggered TXOP sharing procedure. For example, the TXOP sharing mode subfield may be set to a non-zero value (e.g., 1, 2, . . . ) which indicates the triggered TXOP sharing mode 1 or the triggered TXOP sharing mode 2. The AID 12 subfield may be set to the AID of a STA that may use the first time period for transmitting and receiving one or more frame. For example, the AID 12 subfield field may be set to the AID of STA 1504. The first time period may be specified in units of microseconds or some other unit of time. In an example, frame 1510 may be an MRTT frame.

On receiving frame 1510, STA 1504 may transmit a second frame 1512 to AP 1502. In an example, frame 1512 may be a CTS frame. STA 1504 may subsequently transmit one or more non-TB PPDUs comprising one or more data frames 1514 and 1518 to STA 1506 during the first time period. STA 1506 may transmit one or more BA frames 1516 and 1520 to STA 1504 in response to data frames 1514 and 1518 respectively.

In an implementation, based on receiving frame 1510 which does not allocate STA 1508 during the first time period, STA 1508 may transition to a doze state. In an example embodiment, STA 1508 may transition to the doze state:
after STA 1508 receives frame 1510 and before STA 1508 receives frame 1512 in response to frame 1510;
after STA 1508 receives frame 1512 in response to frame 1510; or
if STA 1508 does not receive a third frame during a second time period after STA 1508 receives frame 1510.

The third frame may be a data frame, a control frame, or a management frame. A value of the second time period may be a fixed value or may be signaled by a fourth frame sent by AP 1502. The fourth frame may be a beacon frame, a probe response frame, or an association response frame.

In an implementation, STA 1508 may maintain the doze state during a portion of the first time period after STA 1508 transitions to the doze state. In an implementation, STA 1508 may be in an awake state at the end of the first time period or at least from the end of the first time period.

In an implementation, AP 1502 may not transmit a third frame 1522 to STA 1508 during the first time period. AP 1502 may transmit third frame 1522 to STA 1508 after the first time period.

In an implementation, AP 1502 and STA 1508 may exchange indications of support of the TXS PS mode prior to the beginning of example 1500. For example, STA 1508 may include an indication of support of the TXS PS mode in an association request frame to AP 1502. STA 1508 may set a TXS PS mode field (or a TXS PS Support field) to 1 in the association request frame to indicate support of the TXS PS mode. The TXS PS mode field (or TXS PS Support field) may be provided in an EHT MAC Capabilities Information field of the association request frame. AP 1502 may include an indication of support of the TXS PS mode in an association response frame to STA 1508. STA 1508 may set a TXS PS mode field (or a TXS PS Support field) to 1 in the association response frame to indicate support of the TXS PS mode. The TXS PS mode field (or TXS PS Support field) may be provided in an EHT MAC Capabilities Information field of the association response frame.

In an implementation, when STA 1508 indicates support of the TXS PS mode (e.g., TXS PS field set to 1 in the association request frame to AP 1502), AP 1502 may refrain from transmitting to STA 1508 during the first time period (in which STA 1508 is not allocated) because STA 1508 may enter the doze state during the first time period (even if STA 1508 does not actually enter the doze state during the first time period). AP 1502 may continue to use this behavior with respect to STA 1508 for any subsequent TXS time period during which STA 1508 is not allocated. That is, based on STA 1508 having indicated support of the TXS PS mode, AP 1502 may not transmit to STA 1508 during TXS time periods in which STA 1508 is not allocated.

Recently, however, it has been proposed in the 802.11be standard amendment that a STA may return to the AP any remaining time of a time period allocated to the STA (in TXS mode 2) after the STA has finished transmitting its buffered traffic. The AP may use the remaining time of the time period to transmit downlink traffic or may allocate a portion of the remaining time to another STA. For example, referring to FIG. 15, assuming that STA 1504 has no more traffic to transmit after transmitting data frame 1518, STA 1504 may return the remaining time of the first time period after receiving BA frame 1520 from STA 1506. AP 1502 may use the remaining time of the first time period to transmit downlink traffic (e.g., to STA 1506 or 1508) or may allocate a portion of the remaining time (e.g., to STA 1506 or 1508). According to the IEEE 802.11be standard amendment, an AP that supports this “TXOP Return” feature may transmit to an associated STA an EHT MAC Capabilities Information field with a “TXOP Return Support In TXOP Sharing Mode 2” subfield set to 1. This indicates that the AP supports receiving, from a STA allocated in TXS Mode 2, a frame (e.g., QoS Data or QoS Null frame) that includes an HE variant HT Control field with a CAS Control subfield with the RDG/More PPDU subfield equal to 0. The AP may transmit a PPDU a SIFS after receiving the frame with the CAS Control subfield. Conversely, a STA that receives an MRTT frame with the TXOP Sharing Mode subfield equal to 2 may transmit, within an allocated time, a QoS Data or QoS Null frame that includes an HE variant HT Control field with a CAS Control subfield with the RDG/More PPDU subfield equal to 0 to the associated AP from which it has received an EHT Capabilities element with the “TXOP Return Support In TXOP Sharing Mode 2” subfield set to 1.

But, according to existing behavior, an AP may not use returned remaining time of a time period to transmit to, or to allocate a portion of the remaining time to, a STA that indicated support of the TXS PS mode and that was not allocated in the time period. Indeed, as described above, when a STA indicates support of the TXS PS mode and is not allocated during a time period, the AP may not transmit to the STA during the time period because the STA may enter the doze state during the time period. For example, referring to FIG. 15, assuming that STA 1508 indicated support of the TXS PS mode to AP 1502 (e.g., TXS PS field set to 1 in an association request frame to AP 1502), AP 1502 may not transmit to STA 1508 during the first time period (in which STA 1508 is not allocated) even if STA 1504 were to return the remaining time of the first time period to AP 1502 after receiving BA frame 1520. Similarly, AP 1502 may not allocate a portion of the returned remaining time to STA 1508. This may occur even when STA 1508 does not enter the doze state during the first time period.

This behavior may lead to inefficiencies as the AP may be limited in the ways it may use returned remaining time of a TXS time period. For example, the AP may have buffered downlink traffic for a STA that was not allocated in the TXS time period and that has indicated support of the TXS PS mode. Although the STA may be in the awake state during the TXS time period, the AP must wait until the end of the TXS time period before it may transmit the buffered downlink traffic to the STA. In another example, the AP may wish to share a portion of the returned remaining time with the STA. But as the AP may not transmit to the STA during the TXS time period, the AP may not send the time allocation to the STA even though the STA may be in the awake state during the TXS time period.

Embodiments of the present disclosure, as further described below, address the above-described problem. In an aspect, a STA that supports the TXS PS mode may transmit to an AP a frame that indicates enabling or disabling of the TXS PS mode at the STA. The AP may refrain from transmitting to the first STA during a time period of a TXOP in which the STA is not allocated, based on the frame indicating enabling of the TXS PS mode at the STA. The AP may transmit to the first STA after an end of the time period of the TXOP based on the frame indicating enabling of the TXS PS mode at the STA. The STA may transition a power state of the STA to a doze state for the time period of the TXOP based on the frame indicating enabling of the TXS PS mode at the STA. The AP may transmit to the first STA during the time period of the TXOP on condition of the frame indicating disabling of the TXS PS mode at the STA. The STA may remain or operate in an awake state for the time period of the TXOP based on the frame indicating disabling of the TXS PS mode at the STA.

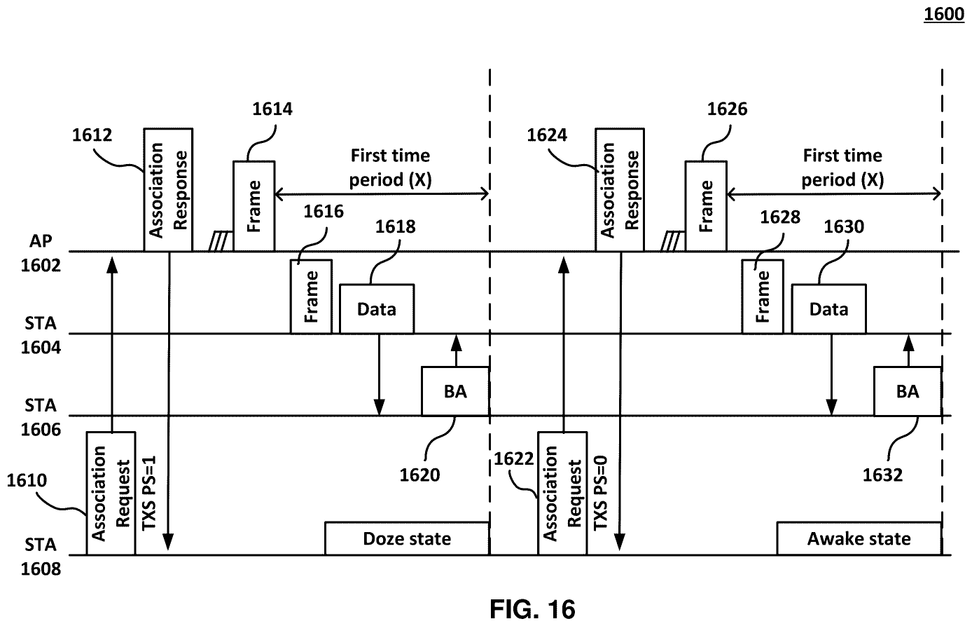

In a first embodiment, the frame that indicates enabling or disabling of the TXS PS mode at the STA may be an association request frame or a reassociation request frame. FIG. 16 is an example 1600 that illustrates such an embodiment. As shown in FIG. 16, example 1600 includes an AP 1602 and STAs 1604, 1606, and 1608. One or more of STAs 1604, 1606, and 1608 may be associated with AP 1602. STAs 1604, 1606, and/or 1608 may support the TXS PS mode as described above.

As shown in FIG. 16, example 1600 may begin with STA 1608 transmitting an association (or reassociation) request frame 1610 to AP 1602. In an example, association request frame 1610 may comprise a TXS PS mode field (or a TXS PS Support field). In example 1600, the TXS PS mode field (or TXS PS Support field) may be set to 1 to indicate enabling of the TXS PS mode at STA 1608. The TXS PS mode field (or TXS PS Support field) may be provided in an EHT MAC Capabilities Information field of the association request frame. AP 1602 may respond to association request frame 1610 by transmitting an association response frame 1612 to STA 1608. In an example, association response frame 1612 may comprise a TXS PS mode field (or a TXS PS Support field). In example 1600, the TXS PS mode field (or TXS PS Support field) may be set to 1 to indicate support of the TXS PS mode at AP 1602. The TXS PS mode field (or TXS PS Support field) may be provided in an EHT MAC Capabilities Information field of the association response frame.

Subsequently, AP 1602 may transmit a frame 1614 to allocate a portion of an obtained TXOP to STA 1604. Frame 1614 may comprise a TXOP sharing mode subfield, an AID 12 subfield, and a first time period (e.g., X us). The TXOP sharing mode subfield may indicate a triggered TXOP sharing procedure. For example, the TXOP sharing mode subfield may be set to a non-zero value (e.g., 1, 2, . . . ) which indicates the triggered TXOP sharing mode 1 or the triggered TXOP sharing mode 2. The AID 12 subfield may be set to the AID of a STA that may use the first time period for transmitting and receiving one or more frame. For example, the AID 12 subfield field may be set to the AID of STA 1604. The first time period may be specified in units of microseconds or some other unit of time. In an example, frame 1614 may be an MRTT frame.

On receiving frame 1614, STA 1604 may transmit a frame 1616 to AP 1602. In an example, frame 1616 may be a CTS frame. STA 1604 may subsequently transmit a non-TB PPDU comprising a data frame 1618 to STA 1606 during the first time period. STA 1606 may transmit a BA frame 1620 to STA 1604 in response to data frame 1618.

Based on receiving frame 1614 which does not allocate STA 1608 during the first time period, and the TXS PS mode being enabled at STA 1608, STA 1608 may transition to a doze state during the first time period. In accordance with the TX PS mode, STA 1608 may transition to the doze state: after STA 1608 receives frame 1614 and before STA 1608 receives frame 1616 in response to frame 1614; after STA 1608 receives frame 1616 in response to frame 1614; or if STA 1608 does not receive a third frame during a second time period after STA 1608 receives frame 1614. The third frame may be a data frame, a control frame, or a management frame. A value of the second time period may be a fixed value or may be signaled by a fourth frame sent by AP 1602. The fourth frame may be a beacon frame, a probe response frame, or an association response frame.

In an implementation, STA 1608 may maintain the doze state during a portion of the first time period after STA 1608 transitions to the doze state. In an implementation, STA 1608 may return to an awake state at the end of the first time period or at least from the end of the first time period. In an implementation, AP 1602 may not transmit a frame to STA 1608 during the first time period. AP 1602 may transmit a frame to STA 1608 after the first time period. In an example (not shown in FIG. 16), AP 1602 may receive from STA 1604, within the first time period, a frame indicating release or return of a remaining time of the first time period. The frame may comprise a QoS Data frame or a QoS Null frame that includes an HE variant HT Control field with a CAS Control subfield with the RDG/More PPDU subfield equal to 0. Based on the TXS PS mode being enabled at STA 1608, AP 1602 may wait for an end of the remaining time before transmitting a frame to STA 1608. In an example, AP 1602 may use the remaining time to transmit a frame to STA 1604 or STA 1606 (assuming STA 1604 or STA 1606 is in the awake state) or to another STA (not shown in FIG. 16, e.g., a legacy STA that does not support TXS PS mode). In another example, AP 1602 may allocate a portion of the remaining time to STA 1606.

In example 1600, STA 1608 may return to the awake state after the end of the first time period or at least from the end of the first time period. Subsequently, STA 1608 may transmit an association (or reassociation) request frame 1622 to AP 1602. In an example, association request frame 1622 may comprise a TXS PS mode field (or a TXS PS Support field). In example 1600, the TXS PS mode field (or TXS PS Support field) may be set to 0 to indicate disabling of the TXS PS mode at STA 1608. The TXS PS mode field (or TXS PS Support field) may be provided in an EHT MAC Capabilities Information field of association request frame 1622. AP 1602 may respond to association request frame 1622 by transmitting an association response frame 1624 to STA 1608. In an example, association response frame 1624 may comprise a TXS PS mode field (or a TXS PS Support field). In example 1600, the TXS PS mode field (or TXS PS Support field) may be set to 1 to indicate support of the TXS PS mode at AP 1602. The TXS PS mode field (or TXS PS Support field) may be provided in an EHT MAC Capabilities Information field of the association response frame.

Subsequently, AP 1602 may transmit a frame 1626 to allocate a portion of an obtained TXOP to STA 1604. Frame 1626 may comprise a TXOP sharing mode subfield, an AID 12 subfield, and a first time period (e.g., X us). The TXOP sharing mode subfield may indicate a triggered TXOP sharing procedure. For example, the TXOP sharing mode subfield may be set to a non-zero value (e.g., 1, 2, . . . ) which indicates the triggered TXOP sharing mode 1 or the triggered TXOP sharing mode 2. The AID 12 subfield may be set to the AID of a STA that may use the first time period for transmitting and receiving one or more frame. For example, the AID 12 subfield field may be set to the AID of STA 1604. The first time period may be specified in units of microseconds or some other unit of time. In an example, frame 1626 may be an MRTT frame.

On receiving frame 1626, STA 1604 may transmit a frame 1628 to AP 1602. In an example, frame 1616 may be a CTS frame. STA 1604 may subsequently transmit a non-TB PPDU comprising a data frame 1630 to STA 1606 during the first time period. STA 1606 may transmit a BA frame 1632 to STA 1604 in response to data frame 1630.

On receiving frame 1626 which does not allocate STA 1608 during the first time period, and based on the TXS PS mode being disabled at STA 1608, STA 1608 may remain in the awake state during the first time period. In an example (not shown in FIG. 16), AP 1602 may receive from STA 1604, within the first time period, a frame indicating release or return of a remaining time of the first time period. The frame may comprise a QoS Data frame or a QoS Null frame that includes an HE variant HT Control field with a CAS Control subfield with the RDG/More PPDU subfield equal to 0. In an example, based on the TXS PS mode being disabled at STA 1608, AP 1602 may transmit a frame to STA 1608 during the remaining time of the first time period. In another example, based on the TXS PS mode being disabled at STA 1608, AP 1602 may allocate a portion of the remaining time to STA 1608. STA 1608 may use the allocated portion of the remaining time to transmit to AP 1602 or to another STA depending on the indicated TXS mode.

An advantage of the first embodiment is that it reuses existing (re)association request/response frames (with minor modification) to enable a STA to signal enabling or disabling of the TXS mode to an AP. However, as (re)association request/response frames may be potentially large in size due to containing information regarding various capabilities supported by the STA/AP, the first embodiment may result in increased signaling overhead. The construction of (re)association request/response frames may also require relatively large processing times at the STA/AP. The signaling by the STA, and the acknowledgment by the AP, of a TXS PS mode state change at the STA may thus require a substantial amount of time, leading to sub-optimal operation.

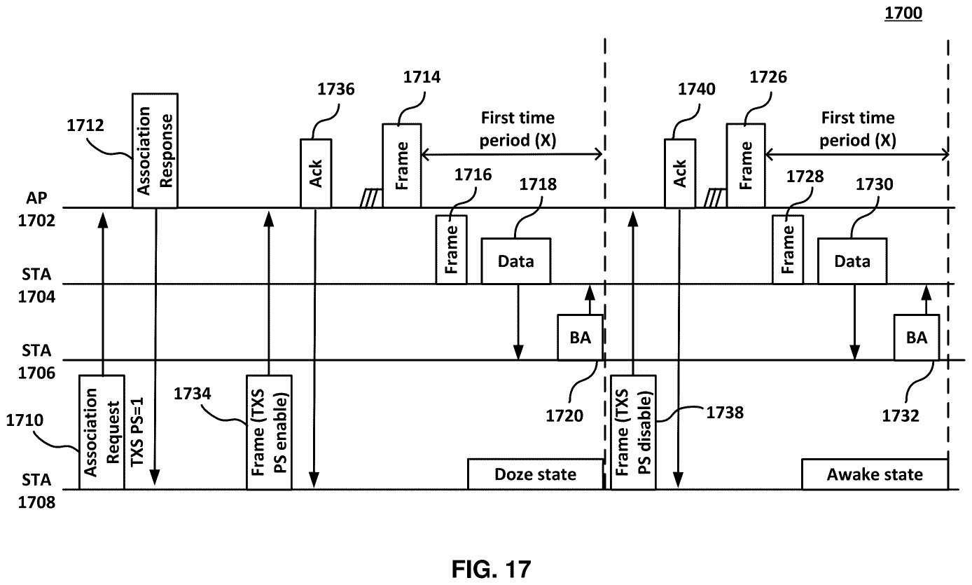

In a second embodiment, the frame that indicates enabling or disabling of the TXS PS mode at the STA may be separate from the frame that signals support of the TXS PS mode at the STA. In embodiments, the frame may be a QoS data frame, a QoS null frame, an action frame, a control frame, or a management frame. The frame may comprise an element or subfield indicating the enabling or disabling of the TXS PS mode at the STA. FIG. 17 is an example 1700 that illustrates such an embodiment. As shown in FIG. 17, example 1700 includes an AP 1702 and STAs 1704, 1706, and 1708. One or more of STAs 1704, 1706, and 1708 may be associated with AP 1702. STAs 1704, 1706, and/or 1708 may support the TXS PS mode as described above.

As shown in FIG. 17, example 1700 may begin with STA 1708 transmitting an association (or reassociation) request frame 1710 to AP 1702. In an example, association request frame 1710 may comprise a TXS PS mode field (or a TXS PS Support field). In example 1700, the TXS PS mode field (or TXS PS Support field) may be set to 1 to indicate support of the TXS PS mode by STA 1708. The TXS PS mode field (or TXS PS Support field) may be provided in an EHT MAC Capabilities Information field of association request frame 1710.

In an implementation, support of the TXS PS mode by STA 1708 may include STA 1708 being able to perform a TXS PS mode operation in a defined condition. In an implementation, the TXS PS mode operation may comprise STA 1708 entering a doze state during a time period of a TXOP. The defined condition may comprise STA 1708 not being allocated by AP 1702 during the time period of the TXOP. In an implementation, support of the TXS PS mode by STA 1708 may include STA 1708 being able to transmit to an AP a frame indicating enabling or disabling of the TXS PS mode as described herein. In an embodiment, the frame may include a TXS PS (TPS) Control subfield (further described below) that indicates enabling or disabling of the TXS PS mode at STA 1708. The TPS Control subfield may include a TPS Disabling subfield that carries the indication of enabling or disabling of the TXS PS mode at STA 1708. In an implementation, support of the TXS PS mode by STA 1708 may include STA 1708 being capable of entering the doze state during a TXS time period that is not allocated to STA 1708 (e.g., by an MRTT frame) when STA 1708 sets the TPS Disabling subfield to 0.

AP 1702 may respond to association request frame 1710 by transmitting an association response frame 1712 to STA 1708. In an example, association response frame 1712 may comprise a TXS PS mode field (or a TXS PS Support field). In example 1700, the TXS PS mode field (or TXS PS Support field) may be set to 1 to indicate support of the TXS PS mode by AP 1702. The TXS PS mode field (or TXS PS Support field) may be provided in an EHT MAC Capabilities Information field of association response frame 1712.

In an implementation, support of the TXS PS mode by AP 1702 may include AP 1702 being able to receive from a STA a frame indicating enabling or disabling of the TXS PS mode at the STA as described herein. In an embodiment, the frame may include a TPS Control subfield that indicates enabling or disabling of the TXS PS mode at the STA. The TPS Control subfield may include a TPS Disabling subfield that carries the indication of enabling or disabling of the TXS PS mode at the STA. In an implementation, support of the TXS PS mode by AP 1702 may further include AP 1702 being able to transmit to the STA an acknowledgment of the frame indicating enabling or disabling of the TXS PS mode at the STA. In an implementation, support of the TXS PS mode by AP 1702 may further include AP 1702 being capable of not transmitting (or refraining from transmitting) any frame, during a TXS time period, to a STA that sets the TPS Disabling subfield to 0 when the TXS time period is not allocated to the STA (e.g., by an MRTT frame).

Subsequently, in an example, STA 1708 may transmit a frame 1734 indicating enabling of the TXS PS mode at STA 1708. Frame 1734 may be a QoS data frame, a QoS null frame, an action frame, a control frame, or a management frame. Frame 1734 may comprise an element or subfield that may be used to indicate enabling or disabling of the TXS PS mode at STA 1708.

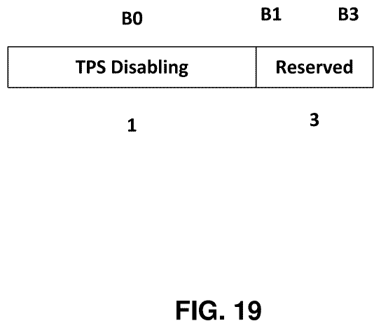

In an example, frame 1734 may be a QoS data or a QoS null frame. The QoS data or QoS null frame may comprise an A-Control field that carries an indication of enabling or disabling the TXS PS mode at STA 1708. The A-Control field may be carried in an HT Control field of the QoS data frame or QoS null frame. In an embodiment, the A-Control field may comprise a TPS Control subfield as illustrated in FIG. 19. The TPS Control subfield may include a TPS Disabling subfield. The TPS Disabling subfield may be set to 0 to indicate enabling of the TXS PS mode at STA 1708 and may be set to 1 to indicate disabling of the TXS PS mode at STA 1708. The TPS Control subfield may further include Reserved bits.

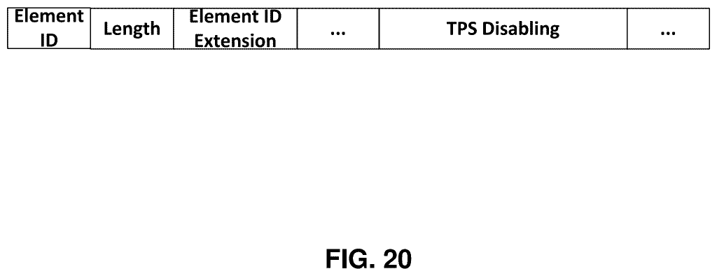

In another example, frame 1734 may be an action frame. The action frame may comprise an element/field indicating enabling or disabling the TXS PS mode at STA 1708. In an example, the action frame may be an EML Operating Mode Notification frame. In an embodiment, the action frame may have a format as illustrated in FIG. 20. As shown in FIG. 20, the action frame may comprise a TPS Disabling subfield. The TPS Disabling subfield may be set to 0 to indicate enabling of the TXS PS mode at STA 1708 and may be set to 1 to indicate disabling of the TXS PS mode at STA 1708. The TPS Control subfield may further include Reserved bits.

In an implementation, AP 1702 may acknowledge frame 1734 by transmitting an acknowledgement frame 1736 to STA 1708. Acknowledgment frame 1736 may be an ACK frame or a BA frame.

Subsequently, AP 1702 may transmit a frame 1714 to allocate a portion of an obtained TXOP to STA 1704. Frame 1714 may comprise a TXOP sharing mode subfield, an AID 12 subfield, and a first time period (e.g., X us). The TXOP sharing mode subfield may indicate a triggered TXOP sharing procedure. For example, the TXOP sharing mode subfield may be set to a non-zero value (e.g., 1, 2, . . . ) which indicates the triggered TXOP sharing mode 1 or the triggered TXOP sharing mode 2. The AID 12 subfield may be set to the AID of a STA that may use the first time period for transmitting and receiving one or more frame. For example, the AID 12 subfield field may be set to the AID of STA 1704. The first time period may be specified in units of microseconds or some other unit of time. In an example, frame 1714 may be an MRTT frame.

On receiving frame 1714, STA 1704 may transmit a frame 1716 to AP 1702. In an example, frame 1716 may be a CTS frame. STA 1704 may subsequently transmit a non-TB PPDU comprising a data frame 1718 to STA 1706 during the first time period. STA 1706 may transmit a BA frame 1720 to STA 1704 in response to data frame 1718.

Based on receiving frame 1714 which does not allocate STA 1708 during the first time period, and the TXS PS mode being enabled at STA 1708, STA 1708 may transition to a doze state during the first time period. In accordance with the TX PS mode, STA 1708 may transition to the doze state: after STA 1708 receives frame 1714 and before STA 1708 receives frame 1716 in response to frame 1714; after STA 1708 receives frame 1716 in response to frame 1714; or if STA 1708 does not receive a third frame during a second time period after STA 1708 receives frame 1714. The third frame may be a data frame, a control frame, or a management frame. A value of the second time period may be a fixed value or may be signaled by a fourth frame sent by AP 1702. The fourth frame may be a beacon frame, a probe response frame, or an association response frame.

In an implementation, STA 1708 may maintain the doze state during a portion of the first time period after STA 1708 transitions to the doze state. In an implementation, STA 1708 may return to an awake state at the end of the first time period or at least from the end of the first time period. In an implementation, AP 1702 may not transmit a frame to STA 1708 during the first time period. AP 1702 may transmit a frame to STA 1708 after the first time period. In an example (not shown in FIG. 17), AP 1702 may receive from STA 1704, within the first time period, a frame indicating release or return of a remaining time of the first time period. The frame may comprise a QoS Data frame or a QoS Null frame that includes an HE variant HT Control field with a CAS Control subfield with the RDG/More PPDU subfield equal to 0. Based on the TXS PS mode being enabled at STA 1708, AP 1702 may wait for an end of the remaining time before transmitting a frame to STA 1708. In an example, AP 1702 may use the remaining time to transmit a frame to STA 1704 or STA 1706 (assuming STA 1704 or STA 1706 is in the awake state) or to another STA (not shown in FIG. 17, e.g., a legacy STA that does not support TXS PS mode). In another example, AP 1702 may allocate a portion of the remaining time to STA 1706.

In example 1700, STA 1708 may return to the awake state after the end of the first time period or at least from the end of the first time period. Subsequently, STA 1708 may transmit a frame 1738 indicating disabling of the TXS PS mode at STA 1708. Frame 1738 may be a QoS data frame, a QoS null frame, an action frame, a control frame, or a management frame. Frame 1738 may comprise an element or subfield that may be used to indicate enabling or disabling of the TXS PS mode at STA 1708. In an example, frame 1738 may be a QoS data or a QoS null frame. The QoS data or QoS null frame may comprise an A-Control field that carries an indication of enabling or disabling the TXS PS mode at STA 1708. The A-Control field may be carried in an HT Control field of the QoS data frame or QoS null frame. In another example, frame 1738 may be an action frame. The action frame may comprise an element/field indicating enabling or disabling the TXS PS mode at STA 1708. In an example, the action frame may be an EML Operating Mode Notification frame.

In an implementation, AP 1702 may acknowledge frame 1738 by transmitting an acknowledgement frame 1740 to STA 1708. Acknowledgment frame 1740 may be an ACK frame or a BA frame.

Subsequently, AP 1702 may transmit a frame 1726 to allocate a portion of an obtained TXOP to STA 1704. Frame 1726 may comprise a TXOP sharing mode subfield, an AID 12 subfield, and a first time period (e.g., X us). The TXOP sharing mode subfield may indicate a triggered TXOP sharing procedure. For example, the TXOP sharing mode subfield may be set to a non-zero value (e.g., 1, 2, . . . ) which indicates the triggered TXOP sharing mode 1 or the triggered TXOP sharing mode 2. The AID 12 subfield may be set to the AID of a STA that may use the first time period for transmitting and receiving one or more frame. For example, the AID 12 subfield field may be set to the AID of STA 1704. The first time period may be specified in units of microseconds or some other unit of time. In an example, frame 1726 may be an MRTT frame.

On receiving frame 1726, STA 1704 may transmit a frame 1728 to AP 1702. In an example, frame 1716 may be a CTS frame. STA 1704 may subsequently transmit a non-TB PPDU comprising a data frame 1730 to STA 1706 during the first time period. STA 1706 may transmit a BA frame 1732 to STA 1704 in response to data frame 1730.

On receiving frame 1726 which does not allocate STA 1708 during the first time period, and based on the TXS PS mode being disabled at STA 1708, STA 1708 may remain in the awake state during the first time period. In an example (not shown in FIG. 17), AP 1702 may receive from STA 1704, within the first time period, a frame indicating release or return of a remaining time of the first time period. The frame may comprise a QoS Data frame or a QoS Null frame that includes an HE variant HT Control field with a CAS Control subfield with the RDG/More PPDU subfield equal to 0. In an example, based on the TXS PS mode being disabled at STA 1708, AP 1702 may transmit a frame to STA 1708 during the remaining time of the first time period. In another example, based on the TXS PS mode being disabled at STA 1708, AP 1702 may allocate a portion of the remaining time to STA 1708. STA 1708 may use the allocated portion of the remaining time to transmit to AP 1702 or to another STA depending on the indicated TXS mode.

Advantages of the second embodiment as illustrated in FIG. 17 include decreased signaling overhead and latency for a STA to signal to an AP a TXS PS mode state change at the STA. As described above, the TXS PS mode state change may be carried in various frame types and is not limited to association request frames. For example, the TXS PS mode state change may be carried in a QoS data/null frame or in a short action frame. The AP may respond to the frame from the STA with a short acknowledgement frame instead of a relatively large association response frame.

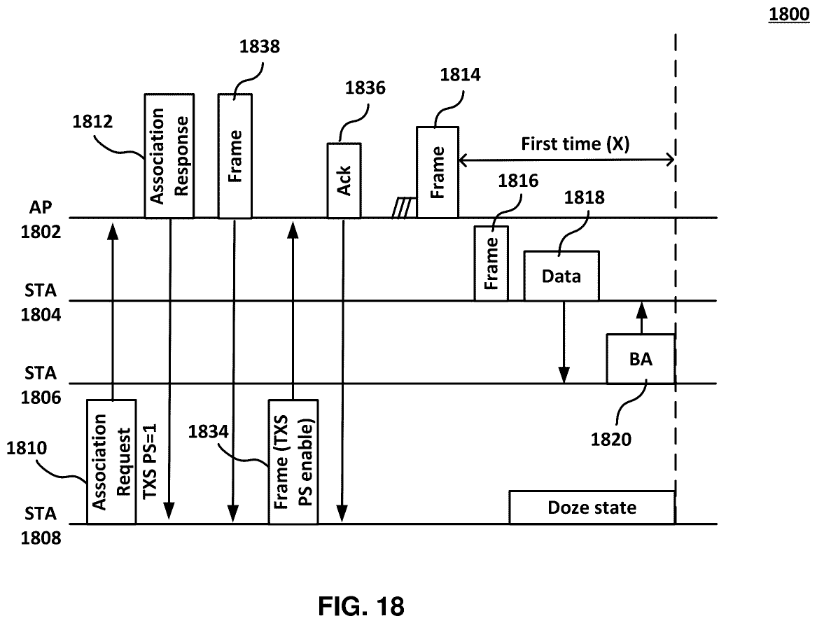

In a third embodiment, similar to the second embodiment, an AP may solicit the TXS PS mode state at a STA. The STA may respond to the solicitation from the AP by transmitting to the AP a frame that indicates enabling or disabling of the TXS PS mode at the STA. In an embodiment, the AP may transmit to the STA a frame soliciting the TXS PS mode state at the STA before initiating a TXS operation. FIG. 18 is an example 1800 that illustrates such an embodiment. As shown in FIG. 18, example 1800 includes an AP 1802 and STAs 1804, 1806, and 1808. One or more of STAs 1804, 1806, and 1808 may be associated with AP 1802. STAs 1804, 1806, and/or 1808 may support the TXS PS mode as described above.

As shown in FIG. 18, example 1800 may begin with STA 1808 transmitting an association (or reassociation) request frame 1810 to AP 1802. In an example, association request frame 1810 may comprise a TXS PS mode field (or a TXS PS Support field). In example 1800, the TXS PS mode field (or TXS PS Support field) may be set to 1 to indicate support of the TXS PS mode by STA 1808. The TXS PS mode field (or TXS PS Support field) may be provided in an EHT MAC Capabilities Information field of association request frame 1810.

In an implementation, support of the TXS PS mode by STA 1808 may include STA 1808 being able to perform a TXS PS mode operation in a defined condition. In an implementation, the TXS PS mode operation may comprise STA 1808 entering a doze state during a time period of a TXOP. The defined condition may comprise STA 1808 not being allocated by AP 1802 during the time period of the TXOP. In an implementation, support of the TXS PS mode by STA 1808 may include STA 1808 being able to transmit to an AP a frame indicating enabling or disabling of the TXS PS mode as described herein. In an embodiment, the frame may include a TPS Control subfield that indicates enabling or disabling of the TXS PS mode at STA 1808. The TPS Control subfield may include a TPS Disabling subfield that carries the indication of enabling or disabling of the TXS PS mode at STA 1808. In an implementation, support of the TXS PS mode by STA 1808 may include STA 1808 being capable of entering the doze state during a TXS time period that is not allocated to STA 1808 (e.g., by an MRTT frame) when STA 1808 sets the TPS Disabling subfield to 0.

AP 1802 may respond to association request frame 1810 by transmitting an association response frame 1812 to STA 1808. In an example, association response frame 1812 may comprise a TXS PS mode field (or a TXS PS Support field). In example 1800, the TXS PS mode field (or TXS PS Support field) may be set to 1 to indicate support of the TXS PS mode by AP 1802. The TXS PS mode field (or TXS PS Support field) may be provided in an EHT MAC Capabilities Information field of association response frame 1812.

In an implementation, support of the TXS PS mode by AP 1802 may include AP 1802 being able to receive from a STA a frame indicating enabling or disabling of the TXS PS mode at the STA as described herein. In an embodiment, the frame may include a TPS Control subfield that indicates enabling or disabling of the TXS PS mode at the STA. The TPS Control subfield may include a TPS Disabling subfield that carries the indication of enabling or disabling of the TXS PS mode at the STA. In an implementation, support of the TXS PS mode by AP 1802 may further include AP 1802 being able to transmit to the STA an acknowledgment of the frame indicating enabling or disabling of the TXS PS mode at the STA. In an implementation, support of the TXS PS mode by AP 1802 may further include AP 1802 being capable of not transmitting (or refraining from transmitting) any frame, during a TXS time period, to a STA that sets the TPS Disabling subfield to 0 when the TXS time period is not allocated to the STA (e.g., by an MRTT frame).

Subsequently, in an example, AP 1802 may transmit to STA 1808 a frame 1838 soliciting the TXS PS mode state at STA 1808. Frame 1838 may be a control frame, a management frame, or an action frame. In an embodiment, AP 1802 may transmit frame 1838 to STA 1808 before initiating a TXS operation. In example 1800, STA 1808 may respond to frame 1838 by transmitting to AP 1802 a frame 1834 indicating enabling of the TXS PS mode at STA 1808. Frame 1834 may be a QoS data frame, a QoS null frame, an action frame, a control frame, or a management frame. Frame 1834 may comprise an element or subfield that may be used to indicate enabling or disabling of the TXS PS mode at STA 1808.

In an example, frame 1834 may be a QoS data or a QoS null frame. The QoS data or QoS null frame may comprise an A-Control field that carries an indication of enabling or disabling the TXS PS mode at STA 1808. The A-Control field may be carried in an HT Control field of the QoS data frame or QoS null frame. In an embodiment, the A-Control field may comprise a TPS Control subfield as illustrated in FIG. 19 described above.

In another example, frame 1834 may be an action frame. The action frame may comprise an element/field indicating enabling or disabling the TXS PS mode at STA 1808. In an example, the action frame may be an EML Operating Mode Notification frame. In an embodiment, the action frame may have a format as illustrated in FIG. 20 described above.

In an implementation, AP 1802 may acknowledge frame 1834 by transmitting an acknowledgement frame 1836 to STA 1808. Acknowledgment frame 1836 may be an ACK frame or a BA frame.

Subsequently, AP 1802 may transmit a frame 1814 to allocate a portion of an obtained TXOP to STA 1804. Frame 1814 may comprise a TXOP sharing mode subfield, an AID 12 subfield, and a first time period (e.g., X us). The TXOP sharing mode subfield may indicate a triggered TXOP sharing procedure. For example, the TXOP sharing mode subfield may be set to a non-zero value (e.g., 1, 2, . . . ) which indicates the triggered TXOP sharing mode 1 or the triggered TXOP sharing mode 2. The AID 12 subfield may be set to the AID of a STA that may use the first time period for transmitting and receiving one or more frame. For example, the AID 12 subfield field may be set to the AID of STA 1804. The first time period may be specified in units of microseconds or some other unit of time. In an example, frame 1814 may be an MRTT frame.

On receiving frame 1814, STA 1804 may transmit a frame 1816 to AP 1802. In an example, frame 1816 may be a CTS frame. STA 1804 may subsequently transmit a non-TB PPDU comprising a data frame 1818 to STA 1806 during the first time period. STA 1806 may transmit a BA frame 1820 to STA 1804 in response to data frame 1818.

Based on receiving frame 1814 which does not allocate STA 1808 during the first time period, and the TXS PS mode being enabled at STA 1808, STA 1808 may transition to a doze state during the first time period. In accordance with the TX PS mode, STA 1808 may transition to the doze state: after STA 1808 receives frame 1814 and before STA 1808 receives frame 1816 in response to frame 1814; after STA 1808 receives frame 1816 in response to frame 1814; or if STA 1808 does not receive a third frame during a second time period after STA 1808 receives frame 1814. The third frame may be a data frame, a control frame, or a management frame. A value of the second time period may be a fixed value or may be signaled by a fourth frame sent by AP 1802. The fourth frame may be a beacon frame, a probe response frame, or an association response frame.

In an implementation, STA 1808 may maintain the doze state during a portion of the first time period after STA 1808 transitions to the doze state. In an implementation, STA 1808 may return to an awake state at the end of the first time period or at least from the end of the first time period. In an implementation, AP 1802 may not transmit a frame to STA 1808 during the first time period. AP 1802 may transmit a frame to STA 1808 after the first time period. In an example (not shown in FIG. 18), AP 1802 may receive from STA 1804, within the first time period, a frame indicating release or return of a remaining time of the first time period. The frame may comprise a QoS Data frame or a QoS Null frame that includes an HE variant HT Control field with a CAS Control subfield with the RDG/More PPDU subfield equal to 0. Based on the TXS PS mode being enabled at STA 1808, AP 1802 may wait for an end of the remaining time before transmitting a frame to STA 1808. In an example, AP 1802 may use the remaining time to transmit a frame to STA 1804 or STA 1806 (assuming STA 1804 or STA 1806 is in the awake state) or to another STA (not shown in FIG. 18, e.g., a legacy STA that does not support TXS PS mode). In another example, AP 1802 may allocate a portion of the remaining time to STA 1806.

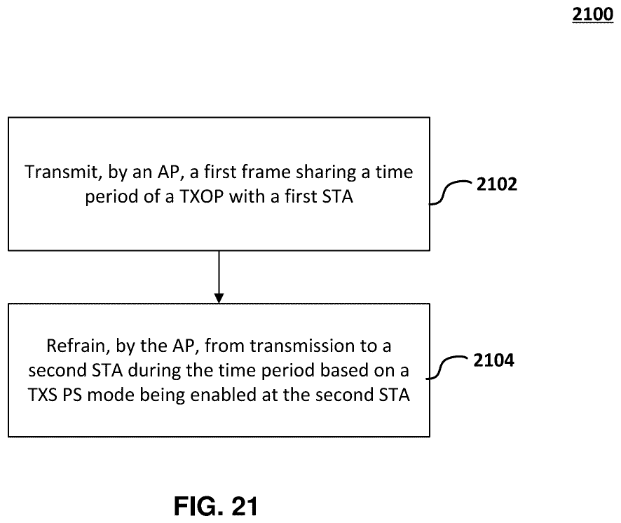

FIG. 21 illustrates an example process 2100 according to an embodiment. Example process 2100 may be performed by an AP, such as AP 1602, AP 1702, or AP 1802 described above. As shown in FIG. 21, process 2100 may include steps 2102 and 2104.

Step 2102 includes transmitting, by the AP, a first frame sharing a time period of a TXOP with a first STA. The first STA may be associated with the AP. The first frame may comprise a trigger frame. The trigger frame may comprise an MRTT frame.

Step 2104 includes refraining, by the AP, from transmission to a second STA during the time period based on a TXS PS mode being enabled at the second STA. The second STA may be associated with the AP. In an embodiment, step 2104 may comprise deferring, postponing, or rescheduling a transmission to the second STA until after the time period based on the TXS PS mode being enabled at the second STA.

In an embodiment, process 2100 may further comprise receiving, by the AP from the second STA, a second frame indicating enabling or disabling of the TXS PS mode at the second STA. In an embodiment, process 2100 may further comprise transmitting, by the AP to the second STA, a frame soliciting the TXS PS mode state at the second STA; and receiving the second frame in response to the soliciting frame.

In an embodiment, the TXS PS mode being enabled at the second STA comprises the second STA performing a TXS PS mode operation in a defined condition. In an embodiment, the TXS PS mode being disabled at the second STA comprises the second STA not performing the TXS PS mode operation in the defined condition. In an embodiment, the defined condition comprises the first frame not sharing the time period of the TXOP with the second STA or not allocating the second STA. In an embodiment, the TXS PS mode operation comprises the second STA entering a doze state during the time period of the TXOP.

In an embodiment, the second frame comprises an association request frame. In an embodiment, the association request frame comprises a TXS PS mode field (or a TXS PS Support field). In an embodiment, where the second frame indicates enabling of the TXS PS mode, the TXS PS mode field (or TXS PS Support field) may be set 1. In an embodiment, where the second frame indicates disabling of the TXS PS mode, the TXS PS mode field (or TXS PS Support field) may be set 0.

In another embodiment, the second frame comprises a QoS data frame, a QoS null frame, an action frame, a control frame, or a management frame. The second frame may comprise an element or subfield indicating the enabling or disabling of the TXS PS mode at the second STA.

In an embodiment, process 2100 may further comprise transmitting, by the AP to the second STA, an acknowledgement frame in response to the second frame. The acknowledgement frame may comprise an ACK frame or a BA frame.

In an embodiment, process 2100 may further comprise receiving, by the AP from the second STA, an association request frame indicating support of the TXS PS mode by the second STA; and transmitting, by the AP to the second STA, an association response frame indicating support of the TXS PS mode by the AP.

In an embodiment, process 2100 may further comprise transmitting, by the AP to the second STA, a third frame after the time period ends.

In an embodiment, process 2100 may further comprise receiving, by the AP from the first STA, a fourth frame indicating release of a remaining period of the time period; and transmitting, by the AP to the second STA, a fifth frame during the remaining period on a condition of the TXS PS mode being disabled at the second STA.

In an embodiment, process 2100 may further comprise receiving, by the AP from the first STA, a fourth frame indicating release of a remaining period of the time period; and transmitting, by the AP to the second STA, a fifth frame after the remaining period based on the TXS PS mode being enabled at the second STA.

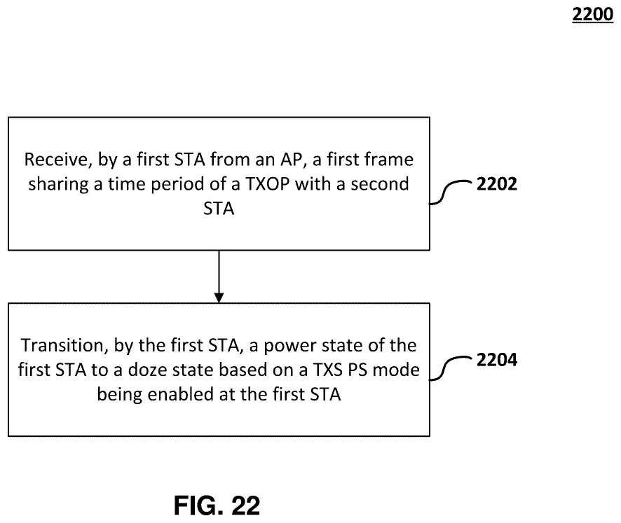

FIG. 22 illustrates another example process 2200 according to an embodiment. Example process 2200 may be performed by a first STA, such as STA 1608, STA 1708, or STA 1808 described above. As shown in FIG. 22, process 2200 may include steps 2202 and 2204.

Step 2202 includes receiving, by first STA from an AP, a first frame sharing a time period of a TXOP with a second STA. The first STA and/or second STA may be associated with the AP. The first frame may comprise a trigger frame. The trigger frame may comprise an MRTT frame.

Step 2204 includes transitioning, by the first STA, a power state of the first STA to a doze state based on a TXS PS mode being enabled at the first STA.

In an embodiment, process 2200 may further comprise transmitting, by the first STA to the AP, a second frame indicating enabling or disabling of the TXS PS mode at the first STA. In an embodiment, process 2200 may further comprise receiving, by the first STA from the AP, a frame soliciting the TXS PS mode state at the first STA; and transmitting the second frame in response to the soliciting frame.

In an embodiment, the TXS PS mode being enabled at the first STA comprises the first STA performing a TXS PS mode operation in a defined condition. In an embodiment, the TXS PS mode being disabled at the first STA comprises the first STA not performing the TXS PS mode operation in the defined condition. In an embodiment, the defined condition comprises the first frame not sharing the time period of the TXOP with the first STA or not allocating the first STA. In an embodiment, the TXS PS mode operation comprises the first STA entering a doze state during the time period of the TXOP.

In an embodiment, the second frame comprises an association request frame. In an embodiment, the association request frame comprises a TXS PS mode field (or a TXS PS Support field). In an embodiment, where the second frame indicates enabling of the TXS PS mode, the TXS PS mode field (or TXS PS Support field) may be set 1. In an embodiment, where the second frame indicates disabling of the TXS PS mode, the TXS PS mode field (or TXS PS Support field) may be set 0.

In another embodiment, the second frame comprises a QoS data frame, a QoS null frame, an action frame, a control frame, or a management frame. The second frame may comprise an element or subfield indicating the enabling or disabling of the TXS PS mode at the first STA.

In an embodiment, process 2200 may further receiving, by the first STA from the AP, an acknowledgement frame in response to the second frame. The acknowledgement frame may comprise an ACK frame or a BA frame.

In an embodiment, process 2200 may further comprise transmitting, by the first STA to the AP, an association request frame indicating support of the TXS PS mode by the first STA; and receiving, by the first STA from the AP, an association response frame indicating support of the TXS PS mode by the AP.

In an embodiment, process 2200 may further comprise receiving, by the first STA from the AP, a third frame after the time period ends.

In another embodiment, process 2200 may further comprise receiving, by the first STA from the AP, a fourth frame during the time period on condition of the TXS PS mode being disabled at the first STA. The AP may transmit the fourth frame to the first STA based on receiving, from the second STA, a fifth frame indicating release of a remaining period of the time period.

1. A method comprising:
receiving, by an access point (AP) from a first station (STA), a first frame requesting a triggered transmit opportunity (TXOP) sharing operation comprising the first STA;
transmitting, by the AP to the first STA, a second frame indicating a response to the first frame;
after transmitting the second frame, transmitting, by the AP, a multi-user request-to-send (MU-RTS) triggered TXOP sharing (TXS) trigger frame sharing a time period of a TXOP with a second STA;
receiving, by the AP in response to the MU-RTS TXS trigger frame, a clear to send (CTS) frame; and
refraining, by the AP, from transmission to the first STA during the time period based on the transmission of the MU-RTS TXS trigger frame being successful.

2. The method of claim 1, wherein the first frame comprises a request frame and wherein the second frame comprises a response frame.

3. The method of claim 2, wherein the first STA and the second STA comprise a connection for peer-to-peer (P2P) communication between the first STA and the second STA.

4. The method of claim 3, wherein the MU-RTS TXS trigger frame further shares the time period of the TXOP with the first STA.

5. The method of claim 4, wherein the first STA and the second STA are comprised in a group of STAs.

6. The method of claim 5, wherein the MU-RTS TXS trigger frame shares the time period of the TXOP with the group of STAs.

7. The method of claim 6, wherein the AP obtains the TXOP and wherein the MU-RTS TXS trigger frame shares the time period within the obtained TXOP.

8. An access point (AP) comprising:
one or more processors; and
memory storing instructions that, when executed by the one or more processors, cause the AP to:
receive, from a first station (STA), a first frame requesting a triggered transmit opportunity (TXOP) sharing operation comprising the first STA;
transmit, to the first STA, a second frame indicating a response to the first frame;
after transmitting the second frame, transmit a multi-user request-to-send (MU-RTS) triggered TXOP sharing (TXS) trigger frame sharing a time period of a TXOP with a second STA;
receive, in response to the MU-RTS TXS trigger frame, a clear to send (CTS) frame; and
refrain from transmission to the first STA during the time period based on the transmission of the MU-RTS TXS trigger frame being successful.

9. The AP of claim 8, wherein the first frame comprises a request frame and wherein the second frame comprises a response frame.

10. The AP of claim 9, wherein the first STA and the second STA comprise a connection for peer-to-peer (P2P) communication between the first STA and the second STA.

11. The AP of claim 10, wherein the MU-RTS TXS trigger frame further shares the time period of the TXOP with the first STA.

12. The AP of claim 11, wherein the first STA and the second STA are comprised in a group of STAs.

13. The AP of claim 12, wherein the MU-RTS TXS trigger frame shares the time period of the TXOP with the group of STAs.

14. The AP of claim 13, wherein the AP obtains the TXOP and wherein the MU-RTS TXS trigger frame shares the time period within the obtained TXOP.

15. A non-transitory computer-readable medium comprising instructions that, when executed by one or more
processors of an Access Point (AP), cause the AP to:
receive, from a first station (STA), a first frame requesting a triggered transmit opportunity (TXOP) sharing operation comprising the first STA;
transmit, to the first STA, a second frame indicating a response to the first frame;
after transmitting the second frame, transmit a multi-user request-to-send (MU-RTS) triggered TXOP sharing (TXS) trigger frame sharing a time period of a TXOP with a second STA;
receive, in response to the MU-RTS TXS trigger frame, a clear to send (CTS) frame; and
refrain from transmission to the first STA during the time period based on the transmission of the MU-RTS TXS trigger frame being successful.

16. The non-transitory computer-readable medium of claim 15, wherein the first frame comprises a request frame and wherein the second frame comprises a response frame.

17. The non-transitory computer-readable medium of claim 16, wherein the first STA and the second STA comprise a connection for peer-to-peer (P2P) communication between the first STA and the second STA.

18. The non-transitory computer-readable medium of claim 17, wherein the MU-RTS TXS trigger frame further shares the time period of the TXOP with the first STA.

19. The non-transitory computer-readable medium of claim 18, wherein the first STA and the second STA are comprised in a group of STAs.

20. The non-transitory computer-readable medium of claim 19, wherein the MU-RTS TXS trigger frame shares the time period of the TXOP with the group of STAs.
